(19) United States
(12) Patent Application Publication
(10) Pub. No.: US 2022/0255169 A1
(43) Pub. Date: Aug. 11, 2022

(54) SECONDARY BATTERY AND BATTERY PACK

(71) Applicant: MURATA MANUFACTURING CO., LTD., Kyoto (JP)

(72) Inventors: Shuichi NAGAOKA, Kyoto (JP); Yoshifumi SHIMIZU, Kyoto (JP); Yu HATANO, Kyoto (JP)

(21) Appl. No.: 17/733,194

(22) Filed: Apr. 29, 2022

Related U.S. Application Data
(63) Continuation of application No. PCT/JP2020/039226, filed on Oct. 19, 2020.

(30) Foreign Application Priority Data
Oct. 31, 2019 (JP) 2019-198901

(51) Int. Cl. H01M 50/197; H01M 50/172; H01M 50/193; H01M 50/531; H01M 50/543; H01M 10/42

(52) U.S. Cl. CPC H01M 50/197; H01M 50/172; H01M 50/193; H01M 2010/4271; H01M 50/543; H01M 10/4257; H01M 50/531

(57) ABSTRACT

A secondary battery includes a first electrically conductive member, a second electrically conductive member, a battery device, and a sealing member. The second electrically conductive member is opposed to the first electrically conductive member. The battery device is provided between the first electrically conductive member and the second electrically conductive member. The battery device includes two or more electrodes stacked on each other in an opposing direction with a separator interposed therebetween. The electrodes include a first electrode and a second electrode. The first electrode is adjacent to the first electrically conductive member. The second electrode is adjacent to the second electrically conductive member. The sealing member is disposed in at least a portion of a region surrounding the battery device between the first electrically conductive member and the second electrically conductive member.

### CROSS REFERENCE TO RELATED APPLICATIONS

The present application is a continuation of PCT patent application no. PCT/JP2020/039226, filed on Oct. 19, 2020, which claims priority to Japanese patent application no. JP2019-198901 filed on Oct. 31, 2019, the entire contents of which are being incorporated herein by reference.

### BACKGROUND

The present technology generally relates to a secondary battery that includes a battery device including two or more electrodes stacked on each other with a separator interposed therebetween, and a battery pack using the secondary battery.

Various kinds of electronic equipment such as mobile phones have been widely used. Such widespread use has promoted development of a secondary battery as a power source that is smaller in size and lighter in weight and allows for a higher energy density. Such a secondary battery is mounted as it is on electronic equipment, or one or more such secondary batteries are formed into a battery pack to be mounted on the electronic equipment. The secondary battery includes a stacked-type battery device in which two or more electrodes are stacked on each other with a separator interposed therebetween. A configuration of the secondary battery influences a battery characteristic and has therefore been considered in various ways.

Specifically, in order to achieve a low-cost secondary battery with no need of a process of providing an outer package member, a negative electrode is interposed between two portions of a bent positive electrode, and peripheral portions of a current collector of the bent positive electrode are sealed together; alternatively, a positive electrode is interposed between two portions of a bent negative electrode, and peripheral portions of a current collector of the bent negative electrode are sealed together. In order to improve a battery life including a moisture-proof characteristic, a battery structure with a tip of an electrode terminal member being exposed is covered with an outer package member which is a metal foil, and the battery structure is thus hermetically sealed by the outer package member.

### SUMMARY

The present technology generally relates to a secondary battery that includes a battery device including two or more electrodes stacked on each other with a separator interposed therebetween, and a battery pack using the secondary battery.

Although consideration has been given in various ways to improve a battery characteristic of a secondary battery, the secondary battery has not yet achieved a sufficient battery characteristic, and there is still room for improvement in terms thereof.

The present technology has been made in view of such an issue and it is an object of the technology to provide a secondary battery and a battery pack that each make it possible to achieve a superior battery characteristic.

A secondary battery according to an embodiment of the present technology includes a first electrically conductive member, a second electrically conductive member, a battery device, and a sealing member. The second electrically conductive member is opposed to the first electrically conductive member. The battery device is provided between the first electrically conductive member and the second electrically conductive member. The battery device includes two or more electrodes stacked on each other in an opposing direction with a separator interposed therebetween. The opposing direction is a direction in which the first electrically conductive member and the second electrically conductive member are opposed to each other. The electrodes include a first electrode and a second electrode. The first electrode is adjacent to the first electrically conductive member. The second electrode is adjacent to the second electrically conductive member. The sealing member is disposed in at least a portion of a region surrounding the battery device between the first electrically conductive member and the second electrically conductive member. The sealing member includes a first bonding layer, an insulating layer, and a second bonding layer that are stacked in order in the opposing direction. The first bonding layer and the second bonding layer each include a polyolefin-based resin. The insulating layer includes an insulating resin.

The term “polyolefin-based resin” is a generic term for resins or polymer compounds each including one or more of polyolefin, a derivative of polyolefin, and a modified material of polyolefin. The polyolefin may have a chain structure or a cyclic structure. Details of the polyolefin-based resin will be described later. Although the “insulating resin” is not limited to a particular kind, the polyolefin resin is excluded from the “insulating resin” described here.

A battery pack according to an embodiment of the present technology includes a secondary battery, a controller, and a switch. The controller controls operation of the secondary battery. The switch switches the operation of the secondary battery in accordance with an instruction from the controller. The secondary battery has a configuration similar to the configuration of the secondary battery according to the embodiment of the technology described herein.

According to the secondary battery of the embodiment of the present technology, the battery device is disposed between the first electrically conductive member and the second electrically conductive member, and the battery device includes the electrodes stacked on each other with the separator interposed therebetween. In addition, the sealing member is disposed in at least a portion of the region surrounding the battery device between the first electrically conductive member and the second electrically conductive member. The sealing member includes: the first bonding layer including the polyolefin-based resin; the insulating layer including the insulating resin; and the second bonding layer including the polyolefin-based resin. This makes it possible to achieve a superior battery characteristic. It is also possible to achieve a similar effect with the battery pack according to the embodiment of the technology.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery with no electrode terminal according to an embodiment of the present technology.

FIG. 2 is a sectional view of the configuration of the secondary battery taken along a line A-A illustrated in FIG. 1.

FIG. 3 is a sectional view of the configuration of the secondary battery taken along a line B-B illustrated in FIG. 1.

FIG. 4 is a perspective view of a configuration of a secondary battery with an electrode terminal according to an embodiment of the present technology.

FIG. 5 is a sectional view of the configuration of the secondary battery taken along a line A-A illustrated in FIG. 4.

FIG. 6 is a sectional view of the configuration of the secondary battery taken along a line B-B illustrated in FIG. 4.

FIG. 7 is a plan view of a configuration of a sealing member according to an embodiment of the present technology.

FIG. 8 is a sectional view of the configuration of the sealing member.

FIG. 9 is a plan view of another configuration of the sealing member.

FIG. 10 is a sectional view of a configuration of a battery device of Configuration example 1 according to an embodiment of the present technology.

FIG. 11 is another sectional view of the configuration of the battery device of Configuration example 1.

FIG. 12 is a sectional view of a configuration of a battery device of Configuration example 2 according to an embodiment of the present technology.

FIG. 13 is another sectional view of the configuration of the battery device of Configuration example 2.

FIG. 14 is a sectional view of a configuration of a battery device of Configuration example 3 according to an embodiment of the present technology.

FIG. 15 is another sectional view of the configuration of the battery device of Configuration example 3.

FIG. 16 is a sectional view of a configuration of a battery device of Configuration example 4 according to an embodiment of the present technology.

FIG. 17 is another sectional view of the configuration of the battery device of Configuration example 4.

FIG. 18 is a sectional view of a configuration of a battery device of Configuration example 5 according to an embodiment of the present technology.

FIG. 19 is another sectional view of the configuration of the battery device of Configuration example 5.

FIG. 20 is a sectional view of a configuration of a battery device of Configuration example 6 according to an embodiment of the present technology.

FIG. 21 is another sectional view of the configuration of the battery device of Configuration example 6.

FIG. 22 is a sectional view of a configuration of a secondary battery with an electrode terminal of Modification 1 according to an embodiment of the present technology.

FIG. 23 is another sectional view of the configuration of the secondary battery with the electrode terminal of Modification 1.

FIG. 24 is a plan view of a configuration of a sealing member to be used in a battery device of Modification 1.

FIG. 25 is a sectional view of a configuration of a battery device of Modification 2 according to an embodiment of the present technology.

FIG. 26 is another sectional view of the configuration of the battery device of Modification 2.

FIG. 27 is a sectional view of a configuration of a battery device of Modification 3 according to an embodiment of the present technology.

FIG. 28 is another sectional view of the configuration of the battery device of Modification 3.

FIG. 29 is a sectional view of a configuration of a battery device of Modification 4 according to an embodiment of the present technology.

FIG. 30 is another sectional view of the configuration of the battery device of Modification 4.

FIG. 31 is a sectional view of a configuration of a battery device of Modification 5 according to an embodiment of the present technology.

FIG. 32 is another sectional view of the configuration of the battery device of Modification 5.

FIG. 33 is a sectional view of a configuration of a sealing member of Modification 7 according to an embodiment of the present technology.

FIG. 34 is a block diagram illustrating a configuration of an application example of the secondary battery, which is a battery pack including a single battery according to an embodiment of the present technology.

FIG. 35 is a block diagram illustrating a configuration of an application example of the secondary battery, which is a battery pack including an assembled battery according to an embodiment of the present technology.

FIG. 36 is a block diagram illustrating a configuration of an application example of the secondary battery, which is an electric vehicle according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

A description is first given of a secondary battery according to one embodiment of the present technology.

The secondary battery to be described herein is a secondary battery that obtains a battery capacity using insertion and extraction of an electrode reactant, and includes a positive electrode, a negative electrode, and an electrolytic solution.

In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Examples are given below of a case where the electrode reactant is lithium. A secondary battery using insertion and extraction of lithium as the electrode reactant is a so-called lithium-ion secondary battery.

First, a general configuration of the secondary battery is described. In the following, a description is given of respective configurations of two kinds of secondary batteries: a configuration of a secondary battery 100 with no electrode terminal and a configuration of a secondary battery 200 with an electrode terminal.

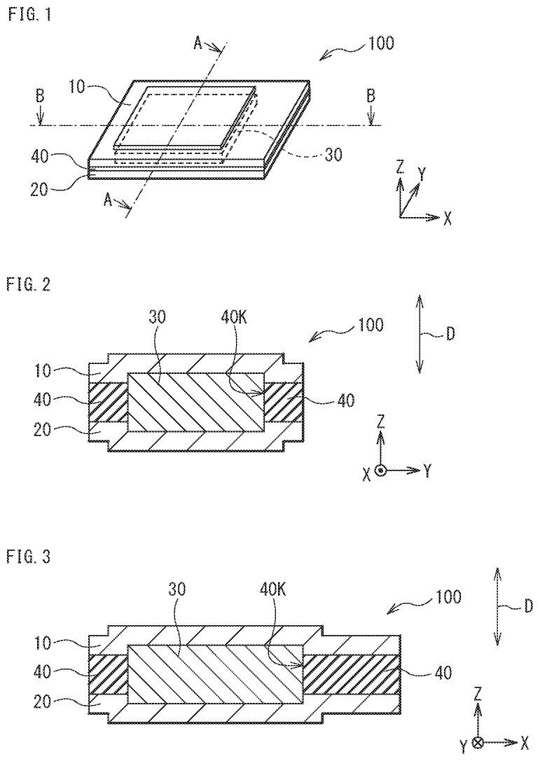

FIG. 1 is a perspective view of the configuration of the secondary battery 100 with no electrode terminal. FIG. 2 is a sectional view of the configuration of the secondary battery 100 taken along a line A-A illustrated in FIG. 1. FIG. 3 is a sectional view of the configuration of the secondary battery 100 taken along a line B-B illustrated in FIG. 1.

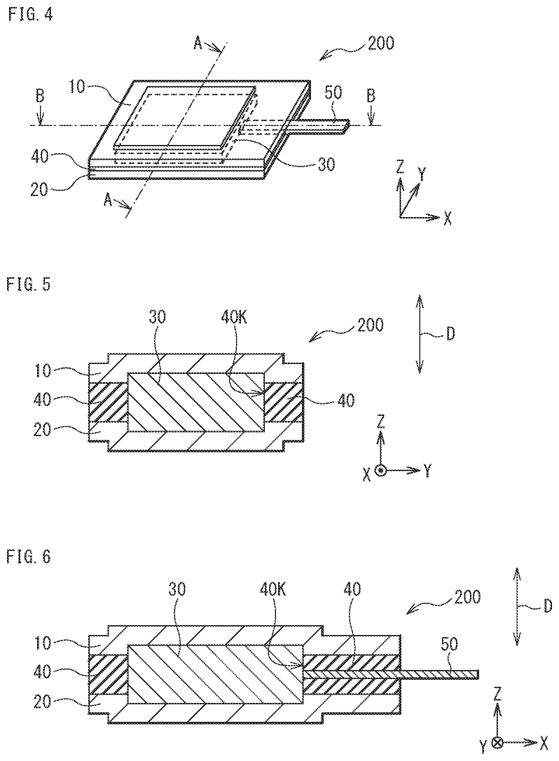

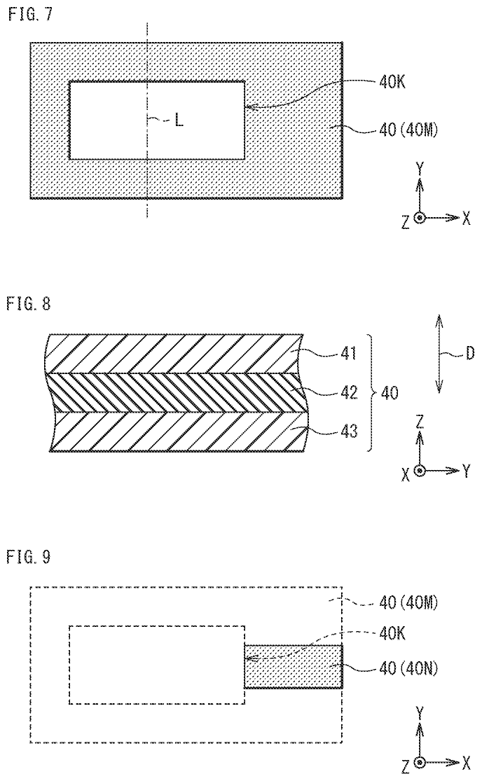

FIG. 4 is a perspective view of the configuration of the secondary battery 200 with the electrode terminal. FIG. 5 is a sectional view of the configuration of the secondary battery 200 taken along a line A-A illustrated in FIG. 4. FIG. 6 is a sectional view of the configuration of the secondary battery 200 taken along a line B-B illustrated in FIG. 4.

FIG. 7 is a plan view of a configuration of a sealing member 40 or 40M. FIG. 8 is a sectional view of the configuration of the sealing member 40. FIG. 9 is a plan view of a configuration of a sealing member 40 or 40N, corresponding to FIG. 7. In FIG. 7, the sealing member 40M, excluding an opening 40K, is shaded. In FIG. 9, the sealing member 40N is shaded, and the sealing member 40M is indicated by a dashed line.

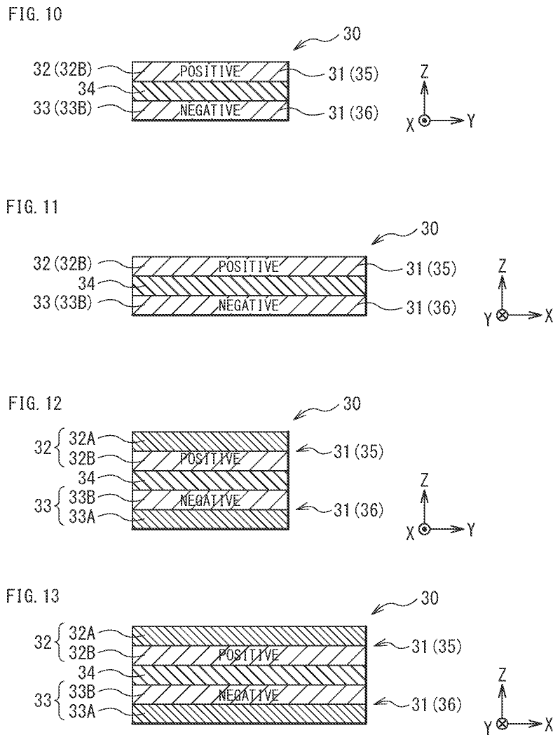

It should be understood that in each of FIGS. 2, 3, 5, and 6, illustration of a configuration of a battery device 30 is done in a schematic manner. A detailed configuration of the battery device 30 will be described later, with reference to FIGS. 10 to 21.

As illustrated in FIGS. 1 to 3, the secondary battery 100 with no electrode terminal includes an upper-layer electrically conductive outer package member 10, a lower-layer electrically conductive outer package member 20, the battery device 30, and the sealing member 40. In the secondary battery 100, the battery device 30 is disposed between the upper-layer electrically conductive outer package member 10 and the lower-layer electrically conductive outer package member 20, and the sealing member 40 is disposed between the upper-layer electrically conductive outer package member 10 and the lower-layer electrically conductive outer package member 20 to surround the battery device 30. Thus, the battery device 30 is contained or enclosed inside a space formed by the upper-layer electrically conductive outer package member 10, the lower-layer electrically conductive outer package member 20, and the sealing member 40.

The upper-layer electrically conductive outer package member 10 is an electrically conductive outer package member used to contain the battery device 30 therein, and corresponds to a first electrically conductive member. The upper-layer electrically conductive outer package member 10 includes one or more of electrically conductive materials. Examples of the electrically conductive materials include metals and alloys. More specifically, the upper-layer electrically conductive outer package member 10 includes a metal foil, for example. It should be understood that as will be described later, the kind of the electrically conductive material is determined depending on the configuration of the battery device 30, i.e., a polarity of the upper-layer electrically conductive outer package member 10. A relationship between the kind of the material, which is the electrically conductive material, included in the upper-layer electrically conductive outer package member 10 and the configuration of the battery device 30 will be described later. In particular, the upper-layer electrically conductive outer package member 10 serves not only as an outer package member but also as a current collector and an electrode terminal, as will be described later. A plan shape, i.e., a shape of a surface along an XY plane, of the upper-layer electrically conductive outer package member 10 is not particularly limited, and examples thereof include a rectangular shape with four sides.

The lower-layer electrically conductive outer package member 20 is an outer package member having a function, a physical property, a material, and a plan shape that are similar to those of the upper-layer electrically conductive outer package member 10 described above, and corresponds to a second electrically conductive member. The lower-layer electrically conductive outer package member 20 is opposed to the upper-layer electrically conductive outer package member 10. As with the upper-layer electrically conductive outer package member 10, the lower-layer electrically conductive outer package member 20 serves not only as an outer package member but also as a current collector and an electrode terminal. It should be understood that, as with the kind of the material (i.e., the electrically conductive material) included in the upper-layer electrically conductive outer package member 10, a kind of a material (i.e., an electrically conductive material) included in the lower-layer electrically conductive outer package member 20 is determined depending on the configuration of the battery device 30 (i.e., a polarity of the lower-layer electrically conductive outer package member 20). Accordingly, the kind of the material included in the lower-layer electrically conductive outer package member 20 may be the same as or different from the kind of the material included in the upper-layer electrically conductive outer package member 10.

The upper-layer electrically conductive outer package member 10 and the lower-layer electrically conductive outer package member 20 are separated away from each other. In a state with the battery device 30 being disposed between the upper-layer electrically conductive outer package member 10 and the lower-layer electrically conductive outer package member 20, respective outer edges of the upper-layer electrically conductive outer package member 10 and the lower-layer electrically conductive outer package member 20 are bonded to each other with the sealing member 40 interposed therebetween.

The battery device 30 is a main part of the secondary battery 100 in which electrode reactions including charging and discharging reactions proceed using insertion and extraction of lithium. The battery device 30 is disposed between the upper-layer electrically conductive outer package member 10 and the lower-layer electrically conductive outer package member 20. A plan shape of the battery device 30 is not particularly limited, and examples thereof include a rectangular shape, as with the respective plan shapes of the upper-layer electrically conductive outer package member 10 and the lower-layer electrically conductive outer package member 20.

As will be described later, the battery device 30 includes two or more electrodes 31, a separator 34, and an electrolytic solution which is a liquid electrolyte, as illustrated in FIGS. 10 to 21. Specifically, the electrodes 31 are stacked on each other in a direction in which the upper-layer electrically conductive outer package member 10 and the lower-layer electrically conductive outer package member 20 are opposed to each other, with the separator 34 being so interposed therebetween as to prevent the electrodes 31 from being in contact with each other. The direction in which the upper-layer electrically conductive outer package member 10 and the lower-layer electrically conductive outer package member 20 are opposed to each other is an opposing direction D along a Z-axis direction. The electrodes 31 and the separator 34 are each impregnated with the electrolytic solution.

It should be understood that in a stack structure including the electrodes 31 and the separator 34, each of an uppermost layer and a lowermost layer is the electrode 31 and not the separator 34. Accordingly, the electrodes 31 include an uppermost-layer electrode 35 and a lowermost-layer electrode 36. The uppermost-layer electrode 35 is the electrode 31 positioned in the uppermost layer of the electrodes 31, i.e., the electrode 31 that is closest to the upper-layer electrically conductive outer package member 10. Such an electrode 31 corresponds to a first electrode. The lowermost-layer electrode 36 is the electrode 31 positioned in the lowermost layer of the electrodes 31, i.e., the electrode 31 that is closest to the lower-layer electrically conductive outer package member 20. Such an electrode 31 corresponds to a second electrode.

The uppermost-layer electrode 35 is adjacent to the upper-layer electrically conductive outer package member 10, and is therefore joined to the upper-layer electrically conductive outer package member 10. That is, the uppermost-layer electrode 35 is electrically coupled to the upper-layer electrically conductive outer package member 10. The lowermost-layer electrode 36 is adjacent to the lower-layer electrically conductive outer package member 20, and is therefore joined to the lower-layer electrically conductive outer package member 20. That is, the lowermost-layer electrode 36 is electrically coupled to the lower-layer electrically conductive outer package member 20.

An area of a plan shape of the separator 34 may be set to be greater than an area of a plan shape of each of the electrodes 31, and each of the electrodes 31 may be therefore disposed inside an outer edge of the separator 34. In other words, an outer edge of each of the electrodes 31 may be recessed inward from the outer edge of the separator 34 rather than protruding outside the outer edge of the separator 34. The position of each of the electrodes 31 is thus adjusted to prevent each of the electrodes 31 from being in contact with each of the upper-layer electrically conductive outer package member 10 and the lower-layer electrically conductive outer package member 20.

Here, as will be described later, the electrodes 31 include a positive electrode 32 and a negative electrode 33. In this case, whether the uppermost-layer electrode 35 is the positive electrode 32 or the negative electrode 33 depends on the configuration of the battery device 30, and whether the lowermost-layer electrode 36 is the positive electrode 32 or the negative electrode 33 depends on the configuration of the battery device 30. A relationship between the kind of each of the uppermost-layer electrode 35 and the lowermost-layer electrode 36 (the positive electrode 32 or the negative electrode 33) and the configuration of the battery device 30 will be described later.

In a case where the electrodes 31 include the positive electrode 32 and the negative electrode 33, an area of the plan shape of each of the positive electrode 32, the negative electrode 33, and the separator 34 may be so set that the following relationship holds: the area of the plan shape of the separator 34≥the area of the plan shape of the negative electrode 33≥the area of the plan shape of the positive electrode 32.

In other words, the area of the plan shape of the separator 34 and the area of the plan shape of the negative electrode 33 may be equal to each other, and the area of the plan shape of the negative electrode 33 and the area of the plan shape of the positive electrode 32 may be equal to each other. In this case, the positive electrode 32, the negative electrode 33, or both may be insulated from the upper-layer electrically conductive outer package member 10, the lower-layer electrically conductive outer package member 20, or both with an insulating member interposed therebetween on an as-needed basis. Examples of the insulating member include an insulating sheet and an insulating film. A material included in the insulating member is not particularly limited, and includes one or more of polymer materials including, without limitation, polyethylene.

The sealing member 40 seals a portion or all of a space surrounding the battery device 30 between the upper-layer electrically conductive outer package member 10 and the lower-layer electrically conductive outer package member 20. Accordingly, the sealing member 40 is disposed in a portion or all of the region surrounding the battery device 30 between the upper-layer electrically conductive outer package member 10 and the lower-layer electrically conductive outer package member 20. The “region surrounding the battery device 30” is a space or a gap present around the battery device 30 between the upper-layer electrically conductive outer package member 10 and the lower-layer electrically conductive outer package member 20 in a state without the sealing member 40 being disposed.

Specifically, as illustrated in FIG. 7, the sealing member 40 has a frame-type plan shape with the opening 40K, and the battery device 30 is disposed inside the opening 40K. In this case, the sealing member 40 is disposed in all of the region surrounding the battery device 30. A plan shape of an outer edge or an outline of the sealing member 40 is not particularly limited, and examples thereof include a rectangular shape, as with the plan shape of each of the upper-layer electrically conductive outer package member 10 and the lower-layer electrically conductive outer package member 20. A plan shape of the opening 40K is not particularly limited, and examples thereof include a shape corresponding to the plan shape of the battery device 30.

In addition, as illustrated in FIG. 8, the sealing member 40 includes a bonding layer 41, an insulating layer 42, and a bonding layer 43 that are stacked in order in the opposing direction D. The bonding layer 41, the insulating layer 42, and the bonding layer 43 are disposed in this order in a direction from the upper-layer electrically conductive outer package member 10 toward the lower-layer electrically conductive outer package member 20.

The bonding layer 41 is a first bonding layer bonded to the upper-layer electrically conductive outer package member 10. The bonding layer 41 includes one or more of polyolefin-based resins that are bondable to the upper-layer electrically conductive outer package member 10 by a method such as a thermal fusion bonding method. More specifically, the bonding layer 41 includes a film including the one or more polyolefin-based resins. The bonding layer 41 may include a single layer or multiple layers. In a case where the bonding layer 41 includes multiple layers, the respective layers of the bonding layer 41 may include the polyolefin-based resins that are the same as or different from each other in kind.

As described above, the term “polyolefin-based resin” is a generic term for resins or polymer compounds each including one or more of a polyolefin, a derivative of a polyolefin, and a modified material of a polyolefin. The polyolefin may have a chain structure or a cyclic structure. The “derivative of a polyolefin” refers to a polyolefin into which one or more functional groups are introduced. The one or more functional groups to be introduced are not particularly limited in kind. The “modified material of a polyolefin” refers to a polyolefin whose property as a whole has changed due to introduction of one or more modifying materials thereinto. The modifying materials to be introduced are not particularly limited in kind. Specific examples of the polyolefin include polypropylene. Specific examples of the polyolefin-based resin include a chain polyolefin, a cyclic polyolefin, a carboxylic-acid-modified chain polyolefin, and a carboxylic-acid-modified cyclic polyolefin. A reason for this is that sufficient adherence is achieved while a sealing characteristic is secured.

In particular, the above-described modifying material preferably includes one or more among acids and acid anhydrides. In other words, the polyolefin-based resin is preferably an acid-modified polyolefin into which one or more materials among the acids and the acid anhydrides are introduced, and is more preferably a polyolefin graft-modified by one or more materials among unsaturated carboxylic acids and unsaturated carboxylic acid anhydrides. A reason for this is that such polyolefin-based resins further improve each of the sealing characteristic and the adherence.

The unsaturated carboxylic acid is not particularly limited in kind, and examples thereof include a maleic acid. The unsaturated carboxylic acid anhydride is not particularly limited in kind, and examples thereof include a maleic acid anhydride.

The bonding layer 41 may further include an insulating filler together with the above-described polyolefin-based resin. The filler includes one or more among inorganic fillers and organic fillers. Examples of the inorganic fillers include a carbon material such as carbon or graphite, silicon oxide (silica), aluminum oxide, barium titanate, iron oxide, silicon carbide, zirconium oxide, zirconium silicate, magnesium oxide, titanium oxide, calcium aluminate, calcium hydroxide, aluminum hydroxide, magnesium hydroxide, and calcium carbonate. Examples of the organic fillers include fluororesin, phenol resin, urea resin, epoxy resin, acrylic resin, benzoguanamine-formaldehyde condensate, melamine-formaldehyde condensate, polymethyl methacrylate crosslinker, and polyethylene crosslinker. A reason for this is that such fillers make it easier to suppress a short circuit between the upper-layer electrically conductive outer package member 10 and the lower-layer electrically conductive outer package member 20.

A thickness of the bonding layer 41 is not particularly limited; however, the thickness of the bonding layer 41 is from 20 μm to 80 μm both inclusive, and is preferably from 30 μm to 50 μm both inclusive. A reason for this is that such a thickness makes it easier to secure each of the sealing characteristic and a bonding characteristic.

The insulating layer 42 includes one or more of insulating resins. More specifically, the insulating layer 42 is a film including the one or more insulating resins. As described below, although the “insulating resin” is not limited to a particular kind, the polyolefin-based resin is excluded from the “insulating resin” described here.

Specifically, the insulating resin includes one or more of resins including a polyester-based resin, a polyamide-based resin, an epoxy-based resin, an acrylic-based resin, a fluorine-based resin, a polyurethane-based resin, a silicon-based resin, and a phenol-based resin. A reason for this is that such an insulating resin secures an insulating characteristic of the sealing member 40. It should be understood that the insulating resin may include a copolymer of any two or more of the above-described resins including the polyester-based resin. The insulating layer 42 may include a single layer or multiple layers. In a case where the insulating layer 42 includes multiple layers, the respective layers of the insulating layer 42 may include the insulating resins that are the same as or different from each other in kind.

The term “polyester-based resin” is a generic term for resins or polymer compounds encompassing polyester and a derivative thereof. The term including a wording “-based”, related to a resin, is thus a generic term for the resin encompassing a derivative thereof. The same holds for other terms including the wording “-based” related to other resins, such as the term “polyamide-based resin”.

In particular, the insulating resin preferably includes the fluorine-based resin. A reason for this is that such an insulating resin improves the insulating characteristic of the sealing member 40.

A thickness of the insulating layer 42 is not particularly limited; however, the thickness of the insulating layer 42 is from 5 μm to 40 μm both inclusive, and is preferably from 10 μm to 30 μm both inclusive. A reason for this is that such a thickness makes it easier to secure each of the sealing characteristic and the bonding characteristic.

The bonding layer 43 is a second bonding layer bonded to the lower-layer electrically conductive outer package member 20. Details of a material included in the bonding layer 43 is similar to the details of the material included in the bonding layer 41 except that the material included in the bonding layer 43 is bondable to the lower-layer electrically conductive outer package member 20 instead of the upper-layer electrically conductive outer package member 10. It should be understood that a kind of the material (the polyolefin-based resin) included in the bonding layer 43 may be the same as or different from the kind of the material (the polyolefin-based resin) included in the bonding layer 41. Further, the bonding layer 43 may include a single layer or multiple layers.

A reason why the sealing member 40 has a multilayer structure including the bonding layers 41 and 43 and the insulating layer 42 is because the bonding layers 41 and 43 improve adherence of the sealing member 40 to each of the upper-layer electrically conductive outer package member 10 and the lower-layer electrically conductive outer package member 20 while the insulating layer 42 secures the insulating characteristic between the upper-layer electrically conductive outer package member 10 and the lower-layer electrically conductive outer package member 20. This prevents the upper-layer electrically conductive outer package member 10 and the lower-layer electrically conductive outer package member 20 which also serve as current collectors from being in contact with each other and being conducted with each other, which helps to prevent a short circuit between the upper-layer electrically conductive outer package member 10 and the lower-layer electrically conductive outer package member 20 from occurring. In addition, because sealing is achieved around the battery device 30, it also helps to prevent a component of the battery device 30, such as the later-described electrolytic solution, from leaking from between the upper-layer electrically conductive outer package member 10 and the lower-layer electrically conductive outer package member 20 to outside.

The number of sealing members 40 is not particularly limited. Accordingly, a single sealing member 40 may be disposed between the upper-layer electrically conductive outer package member 10 and the lower-layer electrically conductive outer package member 20, or two or more sealing members 40 may be disposed between the upper-layer electrically conductive outer package member 10 and the lower-layer electrically conductive outer package member 20. That is, in the latter case, the secondary battery 100 may include the two or more sealing members 40 and the sealing members 40 may be stacked on each other in the opposing direction D. A reason for this is that such a configuration further improves the sealing characteristic around the battery device 30, further helping to prevent the component such as the electrolytic solution from leaking.

As illustrated in FIGS. 4 to 6, the secondary battery 200 with the electrode terminal has a configuration similar to that of the secondary battery 100 with no electrode terminal illustrated in FIGS. 1 to 3, 7, and 8, except that an electrode terminal 50 is additionally included and two or more sealing members 40 are included.

The electrode terminal 50 extends from the battery device 30 in a direction toward outside of each of the upper-layer electrically conductive outer package member 10 and the lower-layer electrically conductive outer package member 20. That is, the electrode terminal 50 has one end joined to the battery device 30 and another end led outside of a region between the upper-layer electrically conductive outer package member 10 and the lower-layer electrically conductive outer package member 20.

Specifically, the electrode terminal 50 is joined to a particular electrode 31 of the two or more electrodes 31, and is therefore electrically coupled to the particular electrode 31. Whether the electrode 31, i.e., the electrode to which the electrode terminal 50 is coupled, is the positive electrode 32 or the negative electrode 33 depends on the configuration of the battery device 30. A relationship between the kind of the electrode 31 to which the electrode terminal 50 is coupled (the positive electrode 32 or the negative electrode 33) and the configuration of the battery device 30 will be described later.

The secondary battery 200 including such an electrode terminal 50 includes the two or more sealing members 40, as described above.

Specifically, the secondary battery 200 may include two frame-type sealing members 40 (40M) each having the opening 40K illustrated in FIG. 7. As described above, each of the two sealing members 40M is disposed in all of the region surrounding the battery device 30. In this case, the two sealing members 40M are overlaid on each other with the electrode terminal 50 interposed therebetween. Thus, as illustrated in FIG. 6, the electrode terminal 50 is sandwiched by the two sealing members 40. The electrode terminal 50 is thereby separated or insulated from each of the upper-layer electrically conductive outer package member 10 and the lower-layer electrically conductive outer package member 20 with corresponding one of the two sealing members 40M interposed therebetween.

Alternatively, the secondary battery 200 may include the frame-type sealing member 40 (40M) having the opening 40K illustrated in FIG. 7 and a non-frame-type sealing member 40 (40N) having no opening 40K illustrated in FIG. 9. The sealing member 40N has a width greater than the width of the electrode terminal 50, and is disposed in a portion of the region surrounding the battery device 30, where the width refers to a dimension in a Y-axis direction. In this case, the sealing members 40M and 40N are overlaid on each other with the electrode terminal 50 interposed therebetween. Therefore, as illustrated in FIG. 6, the electrode terminal 50 is sandwiched by the sealing members 40M and 40N. The electrode terminal 50 is thereby separated or insulated from each of the upper-layer electrically conductive outer package member 10 and the lower-layer electrically conductive outer package member 20 with corresponding one of the sealing members 40M and 40N interposed therebetween.

Next, the detailed configuration of the battery device 30 is described. The battery device 30 to be applied to each of the secondary battery 100 and the secondary battery 200 described above may have various configurations. In the following description, FIGS. 1 to 9 described already will be referred to when necessary.

As described above, the configuration of the battery device 30 is not particularly limited as long as the electrodes 31 are stacked on each other in the opposing direction D with the separator 34 interposed therebetween, and the electrodes 31 include the uppermost-layer electrode 35 and the lowermost-layer electrode 36. That is, regarding the electrodes 31 including the positive electrode 32 and the negative electrode 33, the number of stacked positive electrodes 32 and the number of stacked negative electrodes 33 may each be set to any number. It goes without saying that the number of stacked separators 34 may also be set to any number.

Although the battery device 30 may have configurations of a number of variations, six typical configurations of the battery device 30, i.e., Configuration examples 1 to 6 are described in order below.

FIGS. 10 and 11 each illustrate a sectional view of a configuration of the battery device 30 of Configuration example 1 which is to be applied to the secondary battery 100 with no electrode terminal. FIGS. 10 and 11 correspond to FIGS. 2 and 3, respectively.

As illustrated in FIGS. 10 and 11, the battery device 30 of Configuration example 1 has a stack structure in which two electrodes 31 are stacked with one separator 34 interposed therebetween. The two electrodes 31 include one positive electrode 32 and one negative electrode 33. In other words, the positive electrode 32, the separator 34, and the negative electrode 33 are disposed in this order in the direction from the upper-layer electrically conductive outer package member 10 toward the lower-layer electrically conductive outer package member 20.

In this case, the uppermost-layer electrode 35 is the positive electrode 32 and the lowermost-layer electrode 36 is the negative electrode 33. Accordingly, the positive electrode 32 as the uppermost-layer electrode 35 is adjacent to the upper-layer electrically conductive outer package member 10, and the upper-layer electrically conductive outer package member 10 therefore serves as a current collector of the positive electrode 32. In addition, the negative electrode 33 as the lowermost-layer electrode 36 is adjacent to the lower-layer electrically conductive outer package member 20, and the lower-layer electrically conductive outer package member 20 therefore serves as a current collector of the negative electrode 33.

In order to serve as the current collector of the positive electrode 32, the upper-layer electrically conductive outer package member 10 includes one or more of electrically conductive materials including, without limitation, aluminum, an aluminum alloy, and stainless steel. In order to serve as the current collector of the negative electrode 33, the lower-layer electrically conductive outer package member 20 includes one or more of electrically conductive materials including, without limitation, copper, a copper alloy, stainless steel, nickel, and a nickel-plated steel plate.

The positive electrode 32 as the uppermost-layer electrode 35 includes a positive electrode active material layer 32B. Accordingly, the upper-layer electrically conductive outer package member 10 is adjacent to the positive electrode active material layer 32B which is an active material layer of the positive electrode 32.

The positive electrode active material layer 32B includes one or more of positive electrode active materials into which lithium is insertable and from which lithium is extractable. It should be understood that the positive electrode active material layer 32B may further include, without limitation, a positive electrode binder and a positive electrode conductor.

The positive electrode active material is not particularly limited in kind, and is a lithium-containing compound such as a lithium-containing transition metal compound. The lithium-containing transition metal compound includes lithium and one or more of transition metal elements, and may further include one or more of other elements. The other elements may be any elements other than transition metal elements, and are not limited to particular kinds. In particular, the other elements are preferably those belonging to groups 2 to 15 in the long period periodic table of elements. It should be understood that the lithium-containing transition metal compound may be an oxide or may be any other compound such as a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose. The meaning of the wording “-based” is as described above.

The positive electrode conductor includes one or more of electrically conductive materials including, without limitation, a carbon material. Examples of the carbon material include graphite, carbon black, acetylene black, and Ketjen black. The positive electrode conductor may be a material such as a metal material or an electrically conductive polymer as long as the material is electrically conductive.

The negative electrode 33 as the lowermost-layer electrode 36 includes a negative electrode active material layer 33B. Accordingly, the lower-layer electrically conductive outer package member 20 is adjacent to the negative electrode active material layer 33B which is an active material layer of the negative electrode 33.

The negative electrode active material layer 33B includes one or more of negative electrode active materials into which lithium is insertable and from which lithium is extractable. It should be understood that the negative electrode active material layer 33B may further include, without limitation, a negative electrode binder and a negative electrode conductor. Details of each of the negative electrode binder and the negative electrode conductor are similar to details of each of the positive electrode binder and the positive electrode conductor.

The negative electrode active material is not limited to a particular kind, and examples thereof include a carbon material and a metal-based material. Examples of the carbon material include graphitizable carbon, non-graphitizable carbon, and graphite. The metal-based material includes any of metal elements and metalloid elements that are each able to form an alloy with lithium. More specifically, the metal-based material includes any of materials including, without limitation, silicon and tin. The metal-based material may be a simple substance, an alloy, a compound, or a mixture of two or more thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2 or 0.2<v<1.4), LiSiO, SnO_{w} (0<w≤2), SnSiO₃, LiSnO, and Mg₂Sn.

The separator 34 is an insulating porous film that allows lithium to pass therethrough while preventing a short circuit resulting from contact between the positive electrode 32 and the negative electrode 33. The separator 34 is not limited to a particular configuration such as a material to be included therein. The separator 34 may be a single-layer film or a multilayer film.

Specifically, the separator 34 includes one or more of polymer compounds including, without limitation, polytetrafluoroethylene, polypropylene, and polyethylene.

The separator 34 may be a non-woven separator such as an aramid separator, or may be a ceramic-coated separator. The ceramic-coated separator is a separator with a coat of a material such as alumina being applied on a surface of the above-described porous film, and improves safety of the secondary batteries 100 and 200.

The electrodes 31, including the positive electrode 32 and the negative electrode 33, and the separator 34 are each impregnated with the electrolytic solution, as described above. The electrolytic solution includes a solvent and an electrolyte salt. The electrolytic solution may include only one solvent or may include two or more solvents. The electrolytic solution may include only one electrolyte salt or may include two or more electrolyte salts.

The solvent includes a non-aqueous solvent (an organic solvent). An electrolytic solution including a non-aqueous solvent is a so-called non-aqueous electrolytic solution. Examples of the non-aqueous solvent include a carbonic-acid-ester-based compound, a carboxylic-acid-ester-based compound, and a lactone-based compound. Examples of the carbonic-acid-ester-based compound include ethylene carbonate, propylene carbonate, dimethyl carbonate, diethyl carbonate, and methyl ethyl carbonate. Examples of the carboxylic-acid-ester-based compound include ethyl acetate, ethyl propionate, and ethyl trimethyl acetate. Examples of the lactone-based compound include γ-butyrolactone and γ-valerolactone. Other examples of the non-aqueous solvent include 1,2-dimethoxyethane, tetrahydrofuran, 1,3-dioxolane, and 1,4-dioxane.

The non-aqueous solvent may include one or more of materials including, without limitation, an unsaturated cyclic carbonic acid ester, a halogenated carbonic acid ester, a sulfonic acid ester, a phosphoric acid ester, an acid anhydride, a nitrile compound, and an isocyanate compound.

Examples of the unsaturated cyclic carbonic acid ester include vinylene carbonate, vinylethylene carbonate, and methylene ethylene carbonate. Examples of the halogenated carbonic acid ester include fluoroethylene carbonate and difluoroethylene carbonate. Examples of the sulfonic acid ester include 1,3-propane sultone. Examples of the phosphoric acid ester include trimethyl phosphate. Examples of the acid anhydride include succinic anhydride, glutaric anhydride, maleic anhydride, ethane disulfonic anhydride, propane disulfonic anhydride, sulfobenzoic anhydride, sulfopropionic anhydride, and sulfobutyric anhydride. Examples of the nitrile compound include acetonitrile and succinonitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). A content of the electrolyte salt is not particularly limited; however, the content is from 0.3 mol/kg to 3.0 mol/kg both inclusive with respect to the solvent. A reason for this is that a high ion conductivity is obtainable.

It should be understood that although the uppermost-layer electrode 35 is the positive electrode 32 and the lowermost-layer electrode 36 is the negative electrode 33 here, the battery device 30 may be inverted in the opposing direction D to allow the uppermost-layer electrode 35 to be the negative electrode 33 and allow the lowermost-layer electrode 36 to be the positive electrode 32. In this case, the negative electrode 33 as the uppermost-layer electrode 35 is adjacent to the upper-layer electrically conductive outer package member 10, and the upper-layer electrically conductive outer package member 10 therefore serves as the current collector of the negative electrode 33. In addition, the positive electrode 32 as the lowermost-layer electrode 36 is adjacent to the lower-layer electrically conductive outer package member 20, and the lower-layer electrically conductive outer package member 20 therefore serves as the current collector of the positive electrode 32.

FIGS. 12 and 13 each illustrate a sectional view of a configuration of the battery device 30 of Configuration example 2 to be applied to the secondary battery 100 with no electrode terminal. FIGS. 12 and 13 correspond to FIGS. 2 and 3, respectively. Details of each of the separator 34 and the electrolytic solution are as described above, and the same holds for the following configuration examples.

As illustrated in FIGS. 12 and 13, the battery device 30 of Configuration example 2 has, as with the battery device 30 of Configuration example 1, the stack structure in which two electrodes 31 are stacked with one separator 34 interposed therebetween. The two electrodes 31 include one positive electrode 32 and one negative electrode 33. In other words, the positive electrode 32, the separator 34, and the negative electrode 33 are disposed in this order in the direction from the upper-layer electrically conductive outer package member 10 toward the lower-layer electrically conductive outer package member 20.

In this case, the uppermost-layer electrode 35 is the positive electrode 32 and the lowermost-layer electrode 36 is the negative electrode 33. Therefore, the upper-layer electrically conductive outer package member 10 adjacent to the positive electrode 32 as the uppermost-layer electrode 35 serves as the current collector of the positive electrode 32, and the lower-layer electrically conductive outer package member 20 adjacent to the negative electrode 33 as the lowermost-layer electrode 36 serves as the current collector of the negative electrode 33. Details of the material, i.e., the electrically conductive material, included in each of the upper-layer electrically conductive outer package member 10 and the lower-layer electrically conductive outer package member 20 are similar to those of the battery device 30 of Configuration example 1.

It should be understood that the positive electrode 32 includes the positive electrode current collector 32A and the positive electrode active material layer 32B provided on one side of the positive electrode current collector 32A. The positive electrode active material layer 32B is disposed between the separator 34 and the positive electrode current collector 32A. Accordingly, the upper-layer electrically conductive outer package member 10 is adjacent to the positive electrode current collector 32A which is the current collector of the positive electrode 32, and not to the positive electrode active material layer 32B. The positive electrode current collector 32A includes one or more of electrically conductive materials including, without limitation, aluminum, an aluminum alloy, and stainless steel. Details of the positive electrode active material layer 32B are as described above.

The negative electrode 33 includes the negative electrode current collector 33A and the negative electrode active material layer 33B provided on one side of the negative electrode current collector 33A. The negative electrode active material layer 33B is disposed between the separator 34 and the negative electrode current collector 33A. Accordingly, the lower-layer electrically conductive outer package member 20 is adjacent to the negative electrode current collector 33A which is the current collector of the negative electrode 33, and not to the negative electrode active material layer 33B. The negative electrode current collector 33A includes one or more of electrically conductive materials including, without limitation, copper, a copper alloy, stainless steel, nickel, and a nickel-plated steel plate. Details of the negative electrode active material layer 33B are as described above.

As with the battery device 30 of Configuration example 1, the battery device 30 may be inverted in the opposing direction D to allow the uppermost-layer electrode 35 to be the negative electrode 33 and allow the lowermost-layer electrode 36 to be the positive electrode 32. In this case, the upper-layer electrically conductive outer package member 10 serves as the current collector of the negative electrode 33, and the lower-layer electrically conductive outer package member 20 serves as the current collector of the positive electrode 32, as described above.

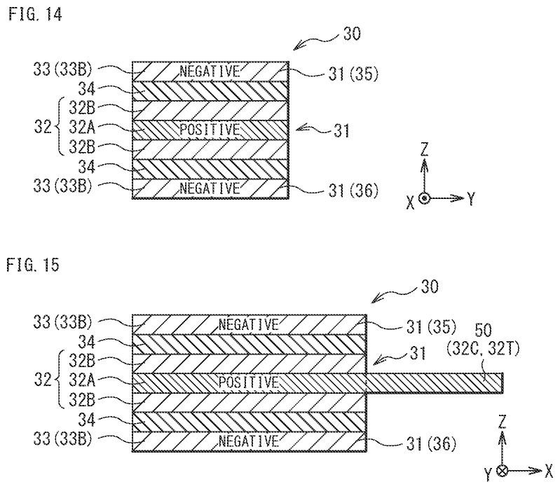

FIGS. 14 and 15 each illustrate a sectional view of a configuration of the battery device 30 of Configuration example 3 to be applied to the secondary battery 200 with the electrode terminal. FIGS. 14 and 15 correspond to FIGS. 5 and 6, respectively.

As illustrated in FIGS. 14 and 15, the battery device 30 of Configuration example 3 has a stack structure in which three electrodes 31 are stacked with two separators 34 interposed therebetween. The three electrodes 31 include one positive electrode 32 and two negative electrodes 33. In other words, the negative electrode 33 as a first negative electrode, the separator 34, the positive electrode 32, the separator 34, and the negative electrode 33 as a second negative electrode are disposed in this order in the direction from the upper-layer electrically conductive outer package member 10 toward the lower-layer electrically conductive outer package member 20.

In this case, the uppermost-layer electrode 35 is the negative electrode 33 and the lowermost-layer electrode 36 is also the negative electrode 33. Accordingly, the negative electrode 33 as the uppermost-layer electrode 35 is adjacent to the upper-layer electrically conductive outer package member 10, and the upper-layer electrically conductive outer package member 10 therefore serves as the current collector of the negative electrode 33. In addition, the negative electrode 33 as the lowermost-layer electrode 36 is adjacent to the lower-layer electrically conductive outer package member 20, and the lower-layer electrically conductive outer package member 20 therefore serves as the current collector of the negative electrode 33. Details of the material (i.e., the electrically conductive material) included in each of the upper-layer electrically conductive outer package member 10 and the lower-layer electrically conductive outer package member 20 serving as the respective current collectors of the negative electrodes 33 are as described above.

The positive electrode 32 includes the positive electrode current collector 32A and two positive electrode active material layers 32B provided on respective opposite sides of the positive electrode current collector 32A. It should be understood that a portion of the positive electrode current collector 32A is led to the outside of the region between the upper-layer electrically conductive outer package member 10 and the lower-layer electrically conductive outer package member 20 to serve as the electrode terminal 50. That is, the positive electrode current collector 32A includes the electrode terminal 50. More specifically, the positive electrode current collector 32A includes a protruding part 32C serving as a positive electrode terminal 32T. The protruding part 32C serving as the positive electrode terminal 32T is joined to a body portion of the positive electrode current collector 32A, i.e., a portion of the positive electrode current collector 32A other than the protruding part 32C, and is provided integrally with the body portion. In FIG. 15, a border between the protruding part 32C and the body portion of the positive electrode current collector 32A is indicated by a dashed line.

However, the protruding part 32C may be provided separately from the positive electrode current collector 32A and physically separated from the positive electrode current collector 32A. In this case, the protruding part 32C may be coupled to the positive electrode current collector 32A by a method such as a welding method.

The negative electrode 33 as the uppermost-layer electrode 35 and the negative electrode 33 as the lowermost-layer electrode 36 each include the negative electrode active material layer 33B. Accordingly, the upper-layer electrically conductive outer package member 10 is adjacent to the negative electrode active material layer 33B which is the active material layer of the negative electrode 33, and the lower-layer electrically conductive outer package member 20 is adjacent to the negative electrode active material layer 33B which is the active material layer of the negative electrode 33. Details of the negative electrode active material layer 33B are as described above.

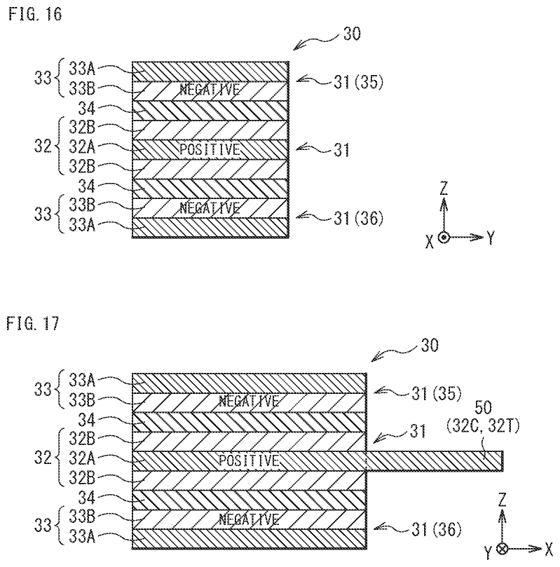

FIGS. 16 and 17 each illustrate a sectional view of a configuration of the battery device 30 of Configuration example 4 to be applied to the secondary battery 200 with the electrode terminal. FIGS. 16 and 17 correspond to FIGS. 5 and 6, respectively.

As illustrated in FIGS. 16 and 17, the battery device 30 of Configuration example 4 has, as with the battery device 30 of Configuration example 3, a stack structure in which three electrodes 31 are stacked with two separators 34 interposed therebetween. The three electrodes 31 include one positive electrode 32 and two negative electrodes 33. In other words, the negative electrode 33, the separator 34, the positive electrode 32, the separator 34, and the negative electrode 33 are disposed in this order in the direction from the upper-layer electrically conductive outer package member 10 toward the lower-layer electrically conductive outer package member 20.

In this case, the uppermost-layer electrode 35 is the negative electrode 33 and the lowermost-layer electrode 36 is also the negative electrode 33. Accordingly, the upper-layer electrically conductive outer package member 10 adjacent to the negative electrode 33 as the uppermost-layer electrode 35 serves as the current collector of the negative electrode 33, and the lower-layer electrically conductive outer package member 20 adjacent to the negative electrode 33 as the lowermost-layer electrode 36 serves as the current collector of the negative electrode 33. Details of the material, i.e., the electrically conductive material, included in each of the upper-layer electrically conductive outer package member 10 and the lower-layer electrically conductive outer package member 20 are similar to those of the battery device 30 of Configuration example 3.

The positive electrode 32 includes the positive electrode current collector 32A and two positive electrode active material layers 32B provided on respective opposite sides of the positive electrode current collector 32A. The positive electrode current collector 32A includes the protruding part 32C serving as the electrode terminal 50, i.e., the positive electrode terminal 32T. Details of each of the positive electrode current collector 32A including the protruding part 32C and the positive electrode active material layer 32B are as described above.

The negative electrode 33 as the uppermost-layer electrode 35 and the negative electrode 33 as the lowermost-layer electrode 36 each include the negative electrode current collector 33A and one negative electrode active material layer 33B provided on one side of the negative electrode current collector 33A. Accordingly, the upper-layer electrically conductive outer package member 10 is adjacent to the negative electrode current collector 33A which is the current collector of the negative electrode 33 as the uppermost-layer electrode 35, and the lower-layer electrically conductive outer package member 20 is adjacent to the negative electrode current collector 33A which is the current collector of the negative electrode 33 as the lowermost-layer electrode 36. Details of each of the negative electrode current collector 33A and the negative electrode active material layer 33B are as described above.

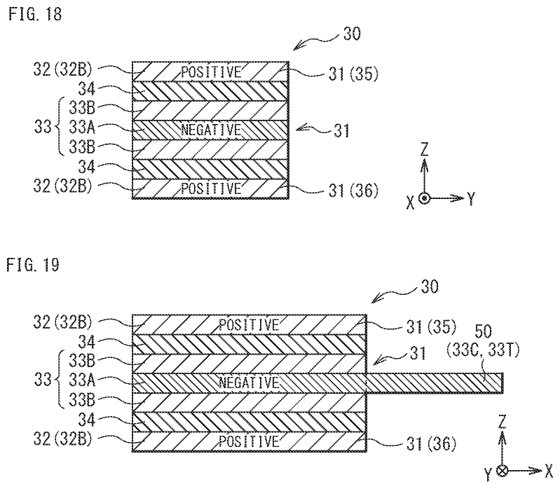

FIGS. 18 and 19 each illustrate a sectional view of a configuration of the battery device 30 of Configuration example 5 to be applied to the secondary battery 200 with the electrode terminal. FIGS. 18 and 19 correspond to FIGS. 5 and 6, respectively.

As illustrated in FIGS. 18 and 19, the battery device 30 of Configuration example 5 has a stack structure in which three electrodes 31 are stacked with two separators 34 interposed therebetween. The three electrodes 31 include two positive electrodes 32 and one negative electrode 33. In other words, the positive electrode 32 as a first positive electrode, the separator 34, the negative electrode 33, the separator 34, and the positive electrode 32 as a second positive electrode are disposed in this order in the direction from the upper-layer electrically conductive outer package member 10 toward the lower-layer electrically conductive outer package member 20.

In this case, the uppermost-layer electrode 35 is the positive electrode 32 and the lowermost-layer electrode 36 is also the positive electrode 32. Accordingly, the positive electrode 32 as the uppermost-layer electrode 35 is adjacent to the upper-layer electrically conductive outer package member 10, and the upper-layer electrically conductive outer package member 10 therefore serves as the current collector of the positive electrode 32. In addition, the positive electrode 32 as the lowermost-layer electrode 36 is adjacent to the lower-layer electrically conductive outer package member 20, and the lower-layer electrically conductive outer package member 20 therefore serves as the current collector of the positive electrode 32. Details of the material, i.e., the electrically conductive material, included in each of the upper-layer electrically conductive outer package member 10 and the lower-layer electrically conductive outer package member 20 serving as the respective current collectors of the positive electrodes 32 are as described above.

The positive electrode 32 as the uppermost-layer electrode 35 and the positive electrode 32 as the lowermost-layer electrode 36 each include the positive electrode active material layer 32B. Accordingly, the upper-layer electrically conductive outer package member 10 is adjacent to the positive electrode active material layer 32B which is the active material layer of the positive electrode 32, and the lower-layer electrically conductive outer package member 20 is adjacent to the positive electrode active material layer 32B which is the active material of the positive electrode 32. Details of the positive electrode active material layer 32B are as described above.

The negative electrode 33 includes the negative electrode current collector 33A and two negative electrode active material layers 33B provided on respective opposite sides of the negative electrode current collector 33A. It should be understood that a portion of the negative electrode current collector 33A is led to the outside of the region between the upper-layer electrically conductive outer package member 10 and the lower-layer electrically conductive outer package member 20 to serve as the electrode terminal 50. That is, the negative electrode current collector 33A includes the electrode terminal 50. More specifically, the negative electrode current collector 33A includes a protruding part 33C serving as a negative electrode terminal 33T. The protruding part 33C serving as the negative electrode terminal 33T is joined to a body portion of the negative electrode current collector 33A, i.e., a portion of the negative electrode current collector 33A other than the protruding part 33C, and is provided integrally with the body portion. In FIG. 19, a border between the protruding part 33C and the body portion of the negative electrode current collector 33A is indicated by a dashed line.

However, the protruding part 33C may be provided separately from the negative electrode current collector 33A and physically separated from the negative electrode current collector 33A. In this case, the protruding part 33C may be coupled to the negative electrode current collector 33A by a method such as a welding method.

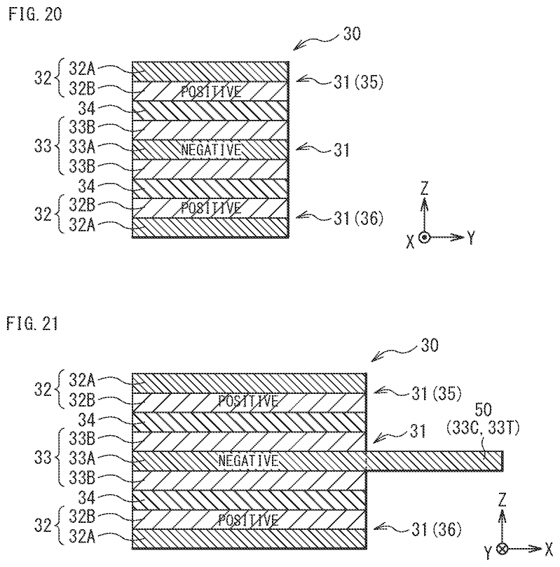

FIGS. 20 and 21 each illustrate a sectional view of a configuration of the battery device 30 of Configuration example 6 to be applied to the secondary battery 200 with the electrode terminal. FIGS. 20 and 21 correspond to FIGS. 5 and 6, respectively.

As illustrated in FIGS. 20 and 21, the battery device 30 of Configuration example 6 has, as with the battery device 30 of Configuration example 5, a stack structure in which three electrodes 31 are stacked with two separators 34 interposed therebetween. The three electrodes 31 include two positive electrodes 32 and one negative electrode 33. In other words, the positive electrode 32, the separator 34, the negative electrode 33, the separator 34, and the positive electrode 32 are disposed in this order in the direction from the upper-layer electrically conductive outer package member 10 toward the lower-layer electrically conductive outer package member 20.

In this case, the uppermost-layer electrode 35 is the positive electrode 32 and the lowermost-layer electrode 36 is also the positive electrode 32. Accordingly, the upper-layer electrically conductive outer package member 10 adjacent to the positive electrode 32 as the uppermost-layer electrode 35 serves as the current collector of the positive electrode 32, and the lower-layer electrically conductive outer package member 20 adjacent to the positive electrode 32 as the lowermost-layer electrode 36 serves as the current collector of the positive electrode 32. Details of the material, i.e., the electrically conductive material, included in each of the upper-layer electrically conductive outer package member 10 and the lower-layer electrically conductive outer package member 20 are similar to those of the battery device 30 of Configuration example 5.

The positive electrode 32 as the uppermost-layer electrode 35 and the positive electrode 32 as the lowermost-layer electrode 36 each include the positive electrode current collector 32A and the positive electrode active material layer 32B provided on one side of the positive electrode current collector 32A. Accordingly, the upper-layer electrically conductive outer package member 10 is adjacent to the positive electrode current collector 32A which is the current collector of the positive electrode 32 as the uppermost-layer electrode 35, and the lower-layer electrically conductive outer package member 20 is adjacent to the positive electrode current collector 32A which is the current collector of the positive electrode 32 as the lowermost-layer electrode 36. Details of each of the positive electrode current collector 32A and the positive electrode active material layer 32B are as described above.

The negative electrode 33 includes the negative electrode current collector 33A and two negative electrode active material layers 33B provided on respective opposite sides of the negative electrode current collector 33A. The negative electrode current collector 33A includes the protruding part 33C serving as the electrode terminal 50, i.e., the negative electrode terminal 33T. Details of each of the negative electrode current collector 33A including the protruding part 33C and the negative electrode active material layer 33B are as described above.

The secondary battery operates as described below. Upon charging, in the battery device 30, lithium is extracted from the positive electrode 32, and the extracted lithium is inserted into the negative electrode 33 via the electrolytic solution. Upon discharging, in the battery device 30, lithium is extracted from the negative electrode 33, and the extracted lithium is inserted into the positive electrode 32 via the electrolytic solution. Upon charging and discharging, lithium is inserted and extracted in an ionic state.

In a case of manufacturing the secondary battery, the battery device 30 is fabricated, following which the secondary battery 100 or 200 is assembled by a procedure described below. In the following description, FIGS. 1 to 21 described already will be referred to when necessary.

In a case of manufacturing the secondary battery 100 with no electrode terminal, first, the electrodes 31 including the positive electrode 32 and the negative electrode 33 are stacked on each other with one or more separators 34 interposed therebetween to thereby form a stacked body. Thereafter, the stacked body is impregnated with the electrolytic solution to thereby fabricate the battery device 30. Details of the stack structure of the battery device 30 are as described above regarding Configuration examples 1 and 2 with reference to FIGS. 10 to 13.

In a case of fabricating the positive electrode 32, first, the positive electrode active material is mixed with, on an as-needed basis, a material such as the positive electrode binder or the positive electrode conductor to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on one side or both sides of the positive electrode current collector 32A to thereby form one or two positive electrode active material layers 32B. Thereafter, the one or two positive electrode active material layers 32B may be compression-molded by means of a machine such as a roll pressing machine. In this case, the one or two positive electrode active material layers 32B may be heated. The one or two positive electrode active material layers 32B may be compression-molded multiple times.

In a case of fabricating the positive electrode 32 without using the positive electrode current collector 32A, after the above-described positive electrode mixture slurry is prepared, the positive electrode mixture slurry may be applied on a surface of the upper-layer electrically conductive outer package member 10, the lower-layer electrically conductive outer package member 20, or both to thereby form one or two positive electrode active material layers 32B.

In a case of fabricating the negative electrode 33, one or two negative electrode active material layers 33B are formed on the negative electrode current collector 33A by a procedure similar to the fabrication procedure of the positive electrode 32 described above. Specifically, the negative electrode active material is mixed with, on an as-needed basis, a material such as the negative electrode binder or the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on one side or both sides of the negative electrode current collector 33A to thereby form one or two negative electrode active material layers 33B. Thereafter, the one or two negative electrode active material layers 33B may be compression-molded.

In a case of fabricating the negative electrode 33 without using the negative electrode current collector 33A, after the above-described negative electrode mixture slurry is prepared, the negative electrode mixture slurry may be applied on a surface of the upper-layer electrically conductive outer package member 10, the lower-layer electrically conductive outer package member 20, or both to thereby form one or two negative electrode active material layers 33B.

In a case of assembling the secondary battery 100, the lower-layer electrically conductive outer package member 20, the sealing member 40 (40M) illustrated in FIGS. 7 and 8, the battery device 30, and the upper-layer electrically conductive outer package member 10 are stacked in this order. In this case, the battery device 30 is placed inside the opening 40K provided in the sealing member 40M. Thereafter, the outer edges of the four sides of the sealing member 40, i.e., of each of the bonding layers 41 and 43, are bonded to each of the upper-layer electrically conductive outer package member 10 and the lower-layer electrically conductive outer package member 20 by a method such as a thermal fusion bonding method. The battery device 30 is thus contained between the upper-layer electrically conductive outer package member 10 and the lower-layer electrically conductive outer package member 20 with the sealing member 40 interposed between the upper-layer electrically conductive outer package member 10 and the lower-layer electrically conductive outer package member 20. Accordingly, the battery device 30 is enclosed between the upper-layer electrically conductive outer package member 10 and the lower-layer electrically conductive outer package member 20. As a result, the secondary battery 100 with no electrode terminal is completed.

In a case of fabricating the secondary battery 200 with the electrode terminal, a procedure similar to the procedure of manufacturing the secondary battery 100 with no electrode terminal is performed, except that: the positive electrode current collector 32A including the protruding part 32C serving as the electrode terminal 50, i.e., the positive electrode terminal 32T or the negative electrode current collector 33A including the protruding part 33C serving as the electrode terminal 50, i.e., the negative electrode terminal 33T, is used; and the sealing member 40, i.e., any of the sealing members 40M and 40N, illustrated in FIGS. 7 to 9 is used. Details of the stack structure of the battery device 30 are as described regarding Configuration examples 3 to 6 with reference to FIGS. 14 to 21. As the sealing member 40, only the frame-type sealing member 40M may be used, or the frame-type sealing member 40M and the non-frame-type sealing member 40N may be used in combination, as described above. The battery device 30 is thus enclosed between the upper-layer electrically conductive outer package member 10 and the lower-layer electrically conductive outer package member 20 with the sealing member 40 interposed between the upper-layer electrically conductive outer package member 10 and the lower-layer electrically conductive outer package member 20, while the electrode terminal 50 is led out from the upper-layer electrically conductive outer package member 10 and the lower-layer electrically conductive outer package member 20. As a result, the secondary battery 200 with the electrode terminal is completed.

According to this secondary battery, i.e., any of the secondary battery 100 with no electrode and the secondary battery 200 with the electrode, the battery device 30 is disposed between the upper-layer electrically conductive outer package member 10 and the lower-layer electrically conductive outer package member 20, and the battery device 30 includes the electrodes 31 stacked on each other with the separator 34 interposed therebetween. In addition, the sealing member 40 is disposed in a portion or all of the region surrounding the battery device 30 between the upper-layer electrically conductive outer package member 10 and the lower-layer electrically conductive outer package member 20. The sealing member 40 includes the bonding layer 41 including the polyolefin-based resin, the insulating layer 42 including the insulating resin, and the bonding layer 43 including the polyolefin-based resin.

In this case, as described above, the bonding layers 41 and 43 improve the adherence of the sealing member 40 to each of the upper-layer electrically conductive outer package member 10 and the lower-layer electrically conductive outer package member 20 while the insulating layer 42 secures the insulating characteristic between the upper-layer electrically conductive outer package member 10 and the lower-layer electrically conductive outer package member 20. This helps to prevent the short circuit between the upper-layer electrically conductive outer package member 10 and the lower-layer electrically conductive outer package member 20 from occurring, and also helps to prevent the component such as the electrolytic solution from leaking from between the upper-layer electrically conductive outer package member 10 and the lower-layer electrically conductive outer package member 20. Accordingly, the charging and discharging reactions using the component such as the electrolytic solution proceed stably and continuously. As a result, it is possible to achieve a superior battery characteristic.

In particular, the polyolefin-based resin may include the acid-modified polyolefin. This improves the sealing characteristic and the adherence of each of the bonding layers 41 and 43. Accordingly, it is possible to achieve higher effects.

Moreover, the insulating resin may include the resin such as the polyester-based resin. This secures the insulating characteristic of the insulating layer 42, helping to sufficiently prevent the short circuit between the upper-layer electrically conductive outer package member 10 and the lower-layer electrically conductive outer package member 20 from occurring. Accordingly, it is possible to achieve higher effects.

Moreover, the positive electrode 32 may include the positive electrode active material layer 32B, and the upper-layer electrically conductive outer package member 10, the lower-layer electrically conductive outer package member 20, or both may be adjacent to the positive electrode active material layer 32B. This allows the charging and discharging reactions to proceed stably while the upper-layer electrically conductive outer package member 10, the lower-layer electrically conductive outer package member 20, or both are used as the current collector of the positive electrode 32 or the current collectors of the positive electrodes 32. Accordingly, it is possible to achieve higher effects. The action and effects described here are also achievable in a case where the negative electrode 33 includes the negative electrode active material layer 33B, and where the upper-layer electrically conductive outer package member 10, the lower-layer electrically conductive outer package member 20, or both are adjacent to the negative electrode active material layer 33B.

Moreover, the positive electrode 32 may include the positive electrode current collector 32A and the positive electrode active material layer 32B, and the upper-layer electrically conductive outer package member 10, the lower-layer electrically conductive outer package member 20, or both may be adjacent to the positive electrode current collector 32A. This allows the charging and discharging reactions to proceed stably while the upper-layer electrically conductive outer package member 10, the lower-layer electrically conductive outer package member 20, or both are used as a portion of the current collector of the positive electrode 32 or as respective portions of the current collectors of the positive electrodes 32. Accordingly, it is possible to achieve higher effects. The action and effects described here are also achievable in a case where the negative electrode 33 includes the negative electrode current collector 33A and the negative electrode active material layer 33B, and where the upper-layer electrically conductive outer package member 10, the lower-layer electrically conductive outer package member 20, or both are adjacent to the negative electrode current collector 33A.

Moreover, the electrodes 31 may include the positive electrode 32 and the negative electrode 33. In addition, the uppermost-layer electrode 35 may be one of the positive electrode 32 and the negative electrode 33, and the lowermost-layer electrode 36 may be the other of the positive electrode 32 and the negative electrode 33. This allows the charging and discharging reactions to proceed stably using one positive electrode 32 and one negative electrode 33. Accordingly, it is possible to achieve higher effects.

Moreover, the electrodes 31 may include the negative electrode 33, the positive electrode 32, and the negative electrode 33. In addition, the uppermost-layer electrode 35 may be one of the two negative electrodes 33, and the lowermost-layer electrode 36 may be the other of the two negative electrodes 33. This allows the charging and discharging reactions to proceed stably using one positive electrode 32 and two negative electrodes 33. Accordingly, it is possible to achieve higher effects. In this case, the electrode terminal 50 serving as the positive electrode terminal 32T may be coupled to the positive electrode 32, and the electrode terminal 50 may be led out to the outside of the region between the upper-layer electrically conductive outer package member 10 and the lower-layer electrically conductive outer package member 20. This allows the charging and discharging reactions to proceed stably using the electrode terminal 50 also in a case where the electrodes 31 include one positive electrode 32 and two negative electrodes 33. Accordingly, it is possible to achieve further higher effects.

Moreover, the electrodes 31 may include the positive electrode 32, the negative electrode 33, and the positive electrode 32. In addition, the uppermost-layer electrode 35 may be one of the two positive electrodes 32, and the lowermost-layer electrode 36 may be the other of the two positive electrodes 32. This allows the charging and discharging reactions to proceed stably using two positive electrodes 32 and one negative electrode 33. Accordingly, it is possible to achieve higher effects. In this case, the electrode terminal 50 serving as the negative electrode terminal 33T may be coupled to the negative electrode 33, and the electrode terminal 50 may be led out to the outside of the region between the upper-layer electrically conductive outer package member 10 and the lower-layer electrically conductive outer package member 20. This allows the charging and discharging reactions to proceed stably using the electrode terminal 50 also in a case where the electrodes 31 include two positive electrodes 32 and one negative electrode 33. Accordingly, it is possible to achieve further higher effects.

Moreover, two or more sealing members 40 may be stacked. This further improves the sealing characteristic around the battery device 30, helping to further prevent the component such as the electrolytic solution from leaking. Accordingly, it is possible to achieve higher effects.

Next, modifications of the foregoing secondary battery will be described. The configuration of the secondary battery is appropriately modifiable, as will be described below with reference to some examples. It should be understood that any two or more of the following series of modifications may be combined.

### [Modification 1]

In the secondary battery 200 with the electrode illustrated in FIGS. 5 and 6, the upper-layer electrically conductive outer package member 10 and the lower-layer electrically conductive outer package member 20 are separated away from each other. Therefore, in a process of manufacturing the secondary battery 200, the outer edges of the four sides of the sealing member 40, i.e., of each of the bonding layers 41 and 43, are bonded to each of the upper-layer electrically conductive outer package member 10 and the lower-layer electrically conductive outer package member 20 by a method such as a thermal fusion bonding method.

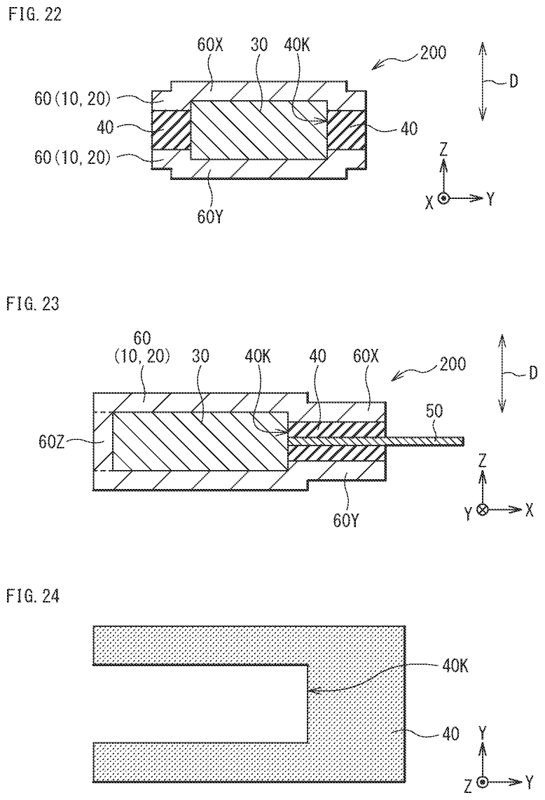

However, as illustrated in FIGS. 22 and 23 corresponding to FIGS. 5 and 6, respectively, the upper-layer electrically conductive outer package member 10 and the lower-layer electrically conductive outer package member 20 may be joined to each other. That is, the secondary battery 200 may include an electrically conductive outer package member 60 serving as both the upper-layer electrically conductive outer package member 10 and the lower-layer electrically conductive outer package member 20, instead of the upper-layer electrically conductive outer package member 10 and the lower-layer electrically conductive outer package member 20.

The electrically conductive outer package member 60 is a single piece of member that is so bent as to serve as both the upper-layer electrically conductive outer package member 10 and the lower-layer electrically conductive outer package member 20. Accordingly, the electrically conductive outer package member 60 includes: an electrically conductive outer package part 60X corresponding to the upper-layer electrically conductive outer package member 10; an electrically conductive outer package part 60Y corresponding to the lower-layer electrically conductive outer package member 20; and a coupling part 60Z coupling the electrically conductive outer package parts 60X and 60Y to each other. Here, the electrically conductive outer package parts 60X and 60Y and the coupling part 60Z together form a single-piece member as a whole, and are therefore integrally provided. However, the electrically conductive outer package parts 60X and 60Y and the coupling part 60Z may form two or three pieces of members in total, and may be therefore provided separately from each other.

Although the illustration in FIG. 23 is simplified, the battery device 30 and the electrically conductive outer package member 60 or the coupling part 60Z may have a gap therebetween depending on a polarity of the electrically conductive outer package member 60. That is, the battery device 30 may be adjacent to the coupling part 60Z, or may be separated away from the coupling part 60Z, depending on the polarity of the electrically conductive outer package member 60.

The battery device 30 of any of Configuration examples 3 to 6 described above is applicable to the secondary battery 200 with the electrode terminal illustrated in FIGS. 22 and 23. That is, the secondary battery 200 may include the battery device 30 of Configuration example 3 illustrated in FIGS. 14 and 15, the battery device 30 of Configuration example 4 illustrated in FIGS. 16 and 17, the battery device 30 of Configuration example 5 illustrated in FIGS. 18 and 19, or the battery device 30 of Configuration example 6 illustrated in FIGS. 20 and 21.

In a case where the secondary battery 200 includes the battery device 30 of Configuration example 3 or 4, the negative electrode 33 as the uppermost-layer electrode 35 and the negative electrode 33 as the lowermost-layer electrode 36 are adjacent to the electrically conductive outer package member 60. Accordingly, the electrically conductive outer package member 60 serves as the respective current collectors of the negative electrodes 33. Details of a material, i.e., an electrically conductive material, included in the electrically conductive outer package member 60 serving as the respective current collectors of the negative electrodes 33 are as described above.

In a case where the secondary battery 200 includes the battery device 30 of Configuration example 5 or 6, the positive electrode 32 as the uppermost-layer electrode 35 and the positive electrode 32 as the lowermost-layer electrode 36 are adjacent to the electrically conductive outer package member 60. Accordingly, the electrically conductive outer package member 60 serves as the respective current collectors of the positive electrodes 32. Details of the material, i.e., the electrically conductive material, included in the electrically conductive outer package member 60 serving as the respective current collectors of the positive electrodes 32 are as described above.

In this case, as illustrated in FIG. 23, a portion of the sealing member 40 may be removed. Specifically, as illustrated in FIG. 24 corresponding to FIG. 7, a portion of the sealing member 40 corresponding to the coupling part 60Z may be cut. That is, the opening 40K may be expanded to reach the electrically conductive outer package member 60 or the coupling part 60Z to thereby allow the sealing member 40 to be partially cut. A reason for this is that, in a case where the electrically conductive outer package member 60 including the coupling part 60Z is used, the battery device 30 is shielded or sealed by the coupling part 60Z. This allows the sealing member 40 to be omittable at a location where the battery device 30 is shielded by the coupling part 60Z.

Instead of removing a portion of the sealing member 40, in a case where the sealing member 40 having the opening 40K illustrated in FIG. 7 is used, the sealing member 40 may be bent, in an X-axis direction, along a bending line L that so extends in the Y-axis direction as to cross the opening 40K.

In a case of manufacturing this secondary battery 200, a procedure similar to the procedure of manufacturing the secondary battery 200 illustrated in FIGS. 5 and 6 is performed, except that the electrically conductive outer package member 60 is used instead of the upper-layer electrically conductive outer package member 10 and the lower-layer electrically conductive outer package member 20. In this case, the electrically conductive outer package member 60 is bent to allow the battery device 30 and the sealing member 40 to be sandwiched between the electrically conductive outer package parts 60X and 60Y. Further, outer edges of three sides of the sealing member 40, i.e., of each of the bonding layers 41 and 43, are bonded to each of the upper-layer electrically conductive outer package member 10 and the lower-layer electrically conductive outer package member 20 by a method such as a thermal fusion bonding method to thereby allow the battery device 30 to be enclosed between the upper-layer electrically conductive outer package member 10 and the lower-layer electrically conductive outer package member 20.

In this case also, the use of the sealing member 40 helps to prevent the short circuit between the upper-layer electrically conductive outer package member 10 and the lower-layer electrically conductive outer package member 20 from occurring, and suppresses leakage of the component such as the electrolytic solution. Accordingly, it is possible to achieve similar effects.

In FIG. 23, the coupling part 60Z is provided on one side in the X-axis direction, i.e., on the left side in FIG. 23, and the electrically conductive outer package parts 60X and 60Y are coupled to each other with such a coupling part 60Z interposed therebetween. However, a position or a range to provide the coupling part 60Z, i.e., a position to bend the electrically conductive outer package member 60, is not particularly limited as long as the electrically conductive outer package parts 60X and 60Y are couplable to each other with the coupling part 60Z interposed therebetween.

Specifically, although not illustrated here, the coupling part 60Z may be provided on one side in the Y-axis direction, i.e., on the foreground side in FIG. 23, and the electrically conductive outer package parts 60X and 60Y may be coupled to each other with such a coupling part 60Z interposed therebetween. Alternatively, the coupling part 60Z may be provided on the other side in the Y-axis direction, i.e., on the background side in FIG. 23, and the electrically conductive outer package parts 60X and 60Y may be coupled to each other with such a coupling part 60Z interposed therebetween.

It goes without saying that any two or more of the coupling part 60Z provided on one side in the X-axis direction (i.e., on the left side in FIG. 23), the coupling part 60Z provided on one side in the Y-axis direction (i.e., on the foreground side in FIG. 23), and the coupling part 60Z provided on the other side in the Y-axis direction (i.e., on the background side in FIG. 23) may be provided, and the electrically conductive outer package parts 60X and 60Y may be coupled to each other with the two or more coupling parts 60Z interposed therebetween.

Accordingly, the sealing member 40 is partially removed not necessarily at one location corresponding to the one coupling part 60Z as illustrated in FIG. 24, and may be partially removed at two or more locations corresponding to the two or more coupling parts 60Z.

### [Modification 2]

In the battery device 30 of Configuration example 4 illustrated in FIGS. 16 and 17, the negative electrode 33, including the negative electrode current collector 33A and the negative electrode active material layer 33B, as the uppermost-layer electrode 35 and the negative electrode 33, including the negative electrode current collector 33A and the negative electrode active material layer 33B, as the lowermost-layer electrode 36 are separated away from each other. In addition, the two separators 34 are also separated away from each other.

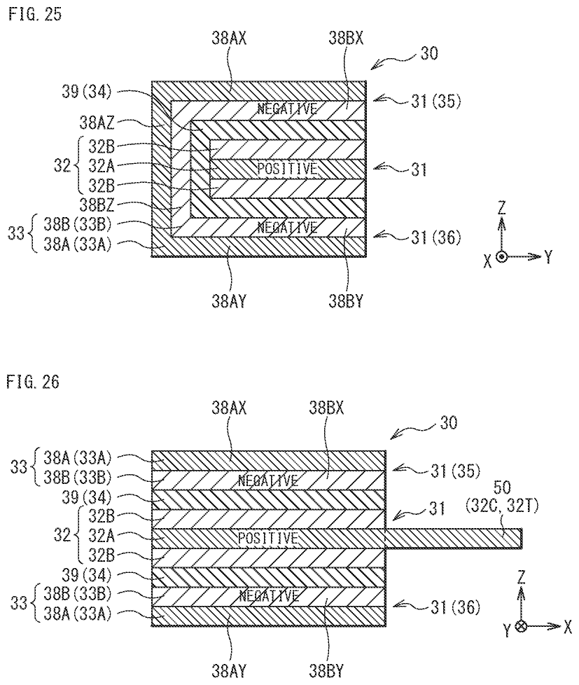

However, as illustrated in FIGS. 25 and 26 corresponding to FIGS. 16 and 17, respectively, the negative electrode 33, including the negative electrode current collector 33A and the negative electrode active material layer 33B, as the uppermost-layer electrode 35 and the negative electrode 33, including the negative electrode current collector 33A and the negative electrode active material layer 33B, as the lowermost-layer electrode 36 may be joined to each other. In addition, the two separators 34 may also be joined to each other. That is, the battery device 30 may include: a negative electrode current collector 38A serving as two negative electrode current collectors 33A; a negative electrode active material layer 38B serving as two negative electrode active material layers 33B; and a separator 39 serving as two separators 34.

The negative electrode current collector 38A is so bent as to serve as both the current collector of the negative electrode 33 as the uppermost-layer electrode 35 and the current collector of the negative electrode 33 as the lowermost-layer electrode 36. Therefore, the negative electrode current collector 38A includes a current collecting part 38AX corresponding to the current collector of the negative electrode 33 as the uppermost-layer electrode 35, a current collecting part 38AY corresponding to the current collector of the negative electrode 33 as the lowermost-layer electrode 36, and a coupling part 38AZ coupling the current collecting parts 38AX and 38AY to each other. Here, the current collecting parts 38AX and 38AY and the coupling part 38AZ together form a single-piece member as a whole, and are therefore integrally provided. However, the current collecting parts 38AX and 38AY and the coupling part 38AZ may form two or three pieces of members in total, and may be therefore provided separately from each other.

The negative electrode active material layer 38B is so bent as to serve as both the active material layer of the negative electrode 33 as the uppermost-layer electrode 35 and the active material layer of the negative electrode 33 as the lowermost-layer electrode 36. Therefore, the negative electrode active material layer 38B includes: an active material part 38BX corresponding to the active material layer of the negative electrode 33 as the uppermost-layer electrode 35; an active material part 38BY corresponding to the active material layer of the negative electrode 33 as the lowermost-layer electrode 36; and a coupling part 38BZ coupling the active material parts 38BX and 38BY to each other. Here, the active material parts 38BX and 38BY and the coupling part 38BZ together form a single-piece member as a whole, and are therefore integrally provided. However, the active material parts 38BX and 38BY and the coupling part 38BZ may form two or three pieces of members in total, and may be therefore provided separately from each other.

In a case of manufacturing this battery device 30, a procedure similar to the procedure of manufacturing the battery device 30 illustrated in FIGS. 16 and 17 is performed, except that the negative electrode current collector 38A, the negative electrode active material layer 38B, and the separator 39 are used instead of the negative electrode current collector 33A, the negative electrode active material layer 33B, and the separator 34. In this case, each of the negative electrode current collector 38A and the separator 39 is bent, and the negative electrode active material layer 38B is formed along the bent negative electrode current collector 38A.

In this case also, the use of the sealing member 40 helps to prevent the short circuit between the upper-layer electrically conductive outer package member 10 and the lower-layer electrically conductive outer package member 20 from occurring, and suppresses leakage of the component such as the electrolytic solution. Accordingly, it is possible to achieve similar effects.

In FIG. 25, the coupling part 38AZ is provided on one side in the Y-axis direction (i.e., on the left side in FIG. 25), and the current collecting parts 38AX and 38AY are coupled to each other with such a coupling part 38AZ interposed therebetween. However, a position or a range to provide the coupling part 38AZ, i.e., a position to bend the negative electrode current collector 38A, is not particularly limited as long as the current collecting parts 38AX and 38AY are couplable to each other with the coupling part 38AZ interposed therebetween.

Specifically, although not illustrated here, the coupling part 38AZ may be provided on one side in the X-axis direction (i.e., on the foreground side in FIG. 25), and the current collecting parts 38AX and 38AY may be coupled to each other with such a coupling part 38AZ interposed therebetween. Alternatively, the coupling part 38AZ may be provided on the other side in the X-axis direction (i.e., on the background side in FIG. 25), and the current collecting parts 38AX and 38AY may be coupled to each other with such a coupling part 38AZ interposed therebetween.

It goes without saying that any two or more of the coupling part 38AZ provided on one side in the Y-axis direction (i.e., on the left side in FIG. 25), the coupling part 38AZ provided on one side in the X-axis direction (i.e., on the foreground side in FIG. 25), and the coupling part 38AZ provided on the other side in the X-axis direction (i.e., on the background side in FIG. 25) may be provided, and the current collecting parts 38AX and 38AY may be coupled to each other with the two or more coupling parts 38AZ interposed therebetween.

The above-described details of the changing of the position to provide the coupling part 38AZ are also applicable to the coupling part 38BZ. That is, in FIG. 25, although the coupling part 38BZ is provided on one side in the Y-axis direction (i.e., on the left side in FIG. 25), the coupling part 38BZ may be provided on one side in the X-axis direction (i.e., on the foreground side in FIG. 25), or may be provided on the other side in the X-axis direction (i.e., on the background side in FIG. 25). It goes without saying that any two or more of the coupling part 38BZ provided on one side in the Y-axis direction (i.e., on the left side in FIG. 25), the coupling part 38BZ provided on one side in the X-axis direction (i.e., on the foreground side in FIG. 25), and the coupling part 38BZ provided on the other side in the X-axis direction (i.e., on the background side in FIG. 25) may be provided.

It should be understood that a relationship between the position of the coupling part 60Z and the position of each of the coupling parts 38AZ and 38BZ may be freely set. That is, the position of the coupling part 60Z may be the same as or different from the position of each of the coupling parts 38AZ and 38BZ.

### [Modification 3]

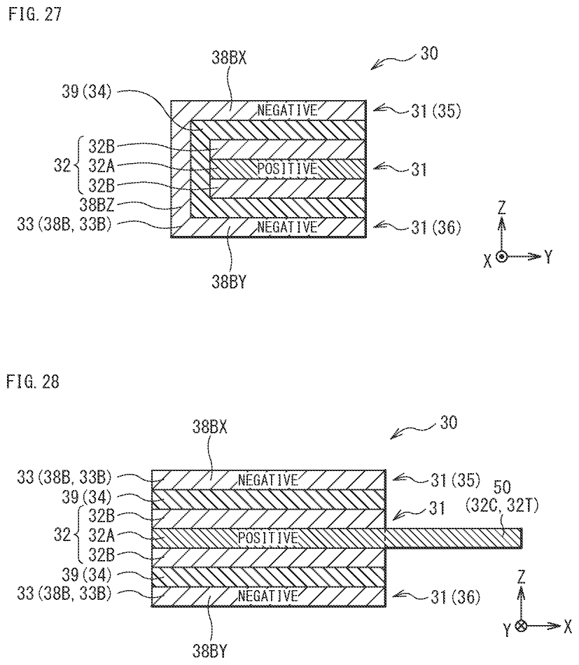

Similarly, as illustrated in FIGS. 27 and 28 corresponding to FIGS. 14 and 15, respectively, in the battery device 30 of Configuration example 3, the negative electrode 33, including the negative electrode active material layer 33B, as the uppermost-layer electrode 35 and the negative electrode 33, including the negative electrode active material layer 33B, as the lowermost-layer electrode 36 may be joined to each other. The configuration of the battery device 30 illustrated in FIGS. 27 and 28 is similar to that of the battery device 30 illustrated in FIGS. 25 and 26, except that no negative electrode current collector 38A is included. In this case also, it is possible to achieve similar effects.

It goes without saying that, also in Modification 3, the position to provide the coupling part 38BZ may be changed as described above in relation to Modification 2.

### [Modification 4]

In the battery device 30 of Configuration example 6 illustrated in FIGS. 20 and 21, the positive electrode 32, including the positive electrode current collector 32A and the positive electrode active material layer 32B, as the uppermost-layer electrode 35 and the positive electrode 32, including the positive electrode current collector 32A and the positive electrode active material layer 32B, as the lowermost-layer electrode 36 are separated away from each other. In addition, the two separators 34 are also separated away from each other.

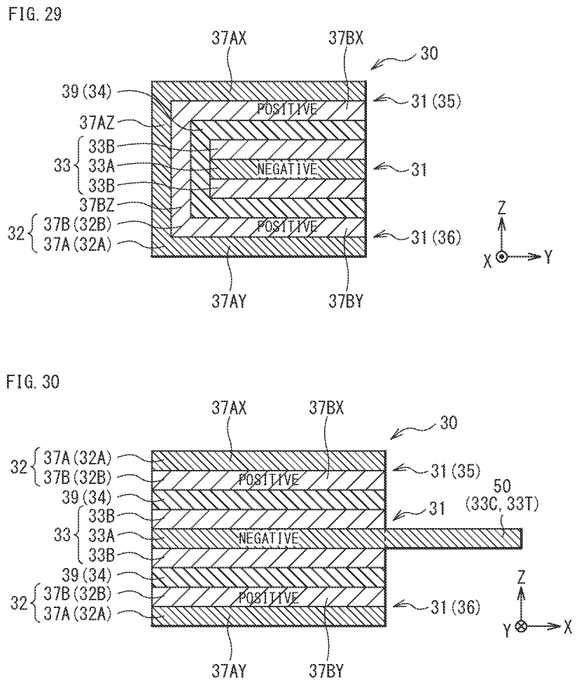

However, as illustrated in FIGS. 29 and 30 corresponding to FIGS. 20 and 21, respectively, the positive electrode 32, including the positive electrode current collector 32A and the positive electrode active material layer 32B, as the uppermost-layer electrode 35 and the positive electrode 32, including the positive electrode current collector 32A and the positive electrode active material layer 32B, as the lowermost-layer electrode 36 may be joined to each other. In addition, the two separators 34 may also be joined to each other. That is, the battery device 30 may include: a positive electrode current collector 37A serving as two positive electrode current collectors 32A; a positive electrode active material layer 37B serving as two positive electrode active material layers 32B; and the separator 39 serving as two separators 34.

The positive electrode current collector 37A is so bent as to serve as both the current collector of the positive electrode 32 as the uppermost-layer electrode 35 and the current collector of the positive electrode 32 as the lowermost-layer electrode 36. Therefore, the positive electrode current collector 37A includes: a current collecting part 37AX corresponding to the current collector of the positive electrode 32 as the uppermost-layer electrode 35; a current collecting part 37AY corresponding to the current collector of the positive electrode 32 as the lowermost-layer electrode 36; and a coupling part 37AZ coupling the current collecting parts 37AX and 37AY to each other. Here, the current collecting parts 37AX and 37AY and the coupling part 37AZ together form a single-piece member as a whole, and are therefore integrally provided. However, the current collecting parts 37AX and 37AY and the coupling part 37AZ may form two or three pieces of members in total, and may be therefore provided separately from each other.

The positive electrode active material layer 37B is so bent as to serve as both the active material layer of the positive electrode 32 as the uppermost-layer electrode 35 and the active material layer of the positive electrode 32 as the lowermost-layer electrode 36. Therefore, the positive electrode active material layer 37B includes: an active material part 37BX corresponding to the active material layer of the positive electrode 32 as the uppermost-layer electrode 35; an active material part 37BY corresponding to the active material layer of the positive electrode 32 as the lowermost-layer electrode 36; and a coupling part 37BZ coupling the active material parts 37BX and 37BY to each other. Here, the active material parts 37BX and 37BY and the coupling part 37BZ together form a single-piece member as a whole, and are therefore integrally provided. However, the active material parts 37BX and 37BY and the coupling part 37BZ may form two or three pieces of members in total, and may be therefore provided separately from each other.

In a case of manufacturing this battery device 30, a procedure similar to the procedure of manufacturing the battery device 30 illustrated in FIGS. 20 and 21 is performed, except that the positive electrode current collector 37A, the positive electrode active material layer 37B, and the separator 39 are used instead of the positive electrode current collector 32A, the positive electrode active material layer 32B, and the separator 34. In this case, each of the positive electrode current collector 37A and the separator 39 is bent, and the positive electrode active material layer 37B is formed along the bent positive electrode current collector 37A.

In this case also, the use of the sealing member 40 helps to prevent the short circuit between the upper-layer electrically conductive outer package member 10 and the lower-layer electrically conductive outer package member 20 from occurring, and suppresses leakage of the component such as the electrolytic solution. Accordingly, it is possible to achieve similar effects.

In FIG. 29, the coupling part 37AZ is provided on one side in the Y-axis direction (i.e., on the left side in FIG. 29), and the current collecting parts 37AX and 37AY are coupled to each other with such a coupling part 37AZ interposed therebetween. However, a position or a range to provide the coupling part 37AZ, i.e., a position to bend the positive electrode current collector 37A, is not particularly limited as long as the current collecting parts 37AX and 37AY are couplable to each other with the coupling part 37AZ interposed therebetween.

Specifically, although not illustrated, the coupling part 37AZ may be provided on one side in the X-axis direction (i.e., on the foreground side in FIG. 29), and the current collecting parts 37AX and 37AY may be coupled to each other with such a coupling part 37AZ interposed therebetween. Alternatively, the coupling part 37AZ may be provided on the other side in the X-axis direction (i.e., on the background side in FIG. 29), and the current collecting parts 37AX and 37AY may be coupled to each other with such a coupling part 37AZ interposed therebetween.

It goes without saying that any two or more of the coupling part 37AZ provided on one side in the Y-axis direction (i.e., on the left side in FIG. 29), the coupling part 37AZ provided on one side in the X-axis direction (i.e., on the foreground side in FIG. 29), and the coupling part 37AZ provided on the other side in the X-axis direction (i.e., on the background side in FIG. 29) may be provided, and the current collecting parts 37AX and 37AY may be coupled to each other with the two or more coupling parts 37AZ interposed therebetween.

The above-described details of the changing of the position to provide the coupling part 37AZ are also applicable to the coupling part 37BZ. That is, in FIG. 29, although the coupling part 37BZ is provided on one side in the Y-axis direction (i.e., on the left side in FIG. 29), the coupling part 37BZ may be provided on one side in the X-axis direction (i.e., on the foreground side in FIG. 29), or may be provided on the other side in the X-axis direction (i.e., on the background side in FIG. 29). It goes without saying that any two or more of the coupling part 37BZ provided on one side in the Y-axis direction (i.e., on the left side in FIG. 29), the coupling part 37BZ provided on one side in the X-axis direction (i.e., on the foreground side in FIG. 29), and the coupling part 37BZ provided on the other side in the X-axis direction (i.e., on the background side in FIG. 29) may be provided.

It should be understood that a relationship between the position of the coupling part 60Z and the position of each of the coupling parts 37AZ and 37BZ may be freely set. That is, the position of the coupling part 60Z may be the same as or different from the position of each of the coupling parts 37AZ and 37BZ.

### [Modification 5]

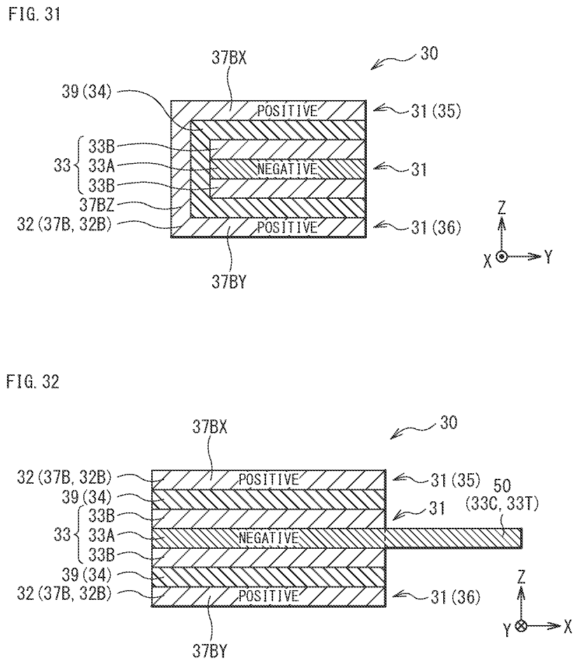

Similarly, as illustrated in FIGS. 31 and 32 corresponding to FIGS. 18 and 19, respectively, in the battery device 30 of Configuration example 5, the positive electrode 32, including the positive electrode active material layer 32B, as the uppermost-layer electrode 35 and the positive electrode 32, including the positive electrode active material layer 32B, as the lowermost-layer electrode 36 may be joined to each other. The configuration of the battery device 30 illustrated in FIGS. 31 and 32 is similar to that of the battery device 30 illustrated in FIGS. 29 and 30, except that no positive electrode current collector 37A is included. In this case also, it is possible to achieve similar effects.

It goes without saying that, also in Modification 5, the position to provide the coupling part 37BZ may be changed as described above in relation to Modification 4.

### [Modification 6]

The configuration of the secondary battery 200 of Modification 1 and the configuration of the battery device 30 of any of Modifications 2 to 5 may be combined with each other.

Specifically, the battery device 30 of Modification 2 illustrated in FIGS. 25 and 26 may be applied to the secondary battery 200 with the electrode terminal illustrated in FIGS. 22 to 24. In this case, the secondary battery 200 includes the electrically conductive outer package member 60, and the battery device 30 includes the negative electrode 33, which includes the negative electrode current collector 38A and the negative electrode active material layer 38B, and the separator 39.

Alternatively, the battery device 30 of Modification 3 may be applied to the secondary battery 200 with the electrode terminal illustrated in FIGS. 22 to 24. In this case, the secondary battery 200 includes the electrically conductive outer package member 60, and the battery device 30 includes the negative electrode 33, which includes the negative electrode active material layer 38B, and the separator 39.

Alternatively, the battery device 30 of Modification 4 illustrated in FIGS. 27 and 28 may be applied to the secondary battery 200 with the electrode terminal illustrated in FIGS. 22 to 24. In this case, the secondary battery 200 includes the electrically conductive outer package member 60, and the battery device 30 includes the positive electrode 32, which includes the positive electrode current collector 37A and the positive electrode active material layer 37B, and the separator 39.

Alternatively, the battery device 30 of Modification 5 may be applied to the secondary battery 200 with the electrode terminal illustrated in FIGS. 22 to 24. In this case, the secondary battery 200 includes the electrically conductive outer package member 60, and the battery device 30 includes the positive electrode 32, which includes the positive electrode active material layer 37B, and the separator 39.

In these cases also, the use of the sealing member 40 helps to prevent a short circuit between the electrodes 31 including the positive electrode 32 and the negative electrode 33, and suppresses leakage of the component such as the electrolytic solution. Accordingly, it is possible to achieve similar effects.

### [Modification 7]

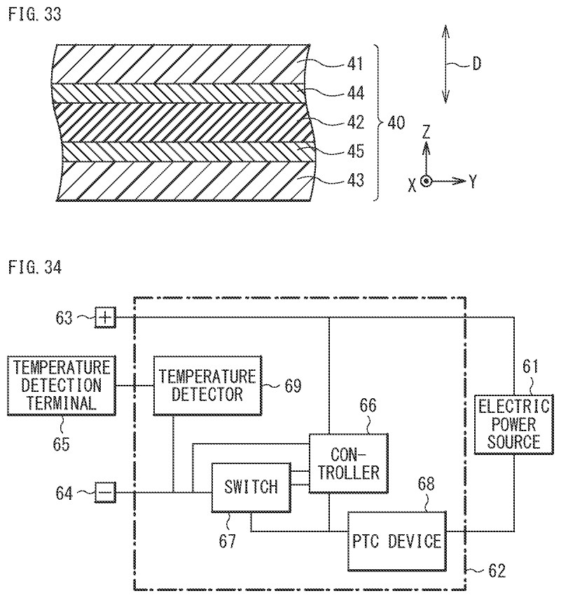

As illustrated in FIG. 33 corresponding to FIG. 8, the sealing member 40 may further include bonding accelerator layers 44 and 45.

The bonding accelerator layer 44 is a first adhesive layer interposed between the bonding layer 41 and the insulating layer 42, and improves adherence between the bonding layer 41 and the insulating layer 42. The bonding accelerator layer 45 is a second adhesive layer interposed between the bonding layer 43 and the insulating layer 42, and improves adherence between the bonding layer 43 and the insulating layer 42. Each of the bonding accelerator layers 44 and 45 includes a bonding accelerator. The bonding accelerator is one or more of an isocyanate-based bonding accelerator, a polyethyleneimine-based bonding accelerator, a polyester-based bonding accelerator, a polyurethane-based bonding accelerator, and a polybutadiene-based bonding accelerator. It should be understood that a kind of the bonding accelerator layer included in the bonding accelerator layer 44 and a kind of the bonding accelerator included in the bonding accelerator layer 45 may be the same as or different from each other.

In particular, the bonding accelerator preferably includes the isocyanate-based bonding accelerator. A reason for this is that this sufficiently improves adherence between the bonding layer 41 and the insulating layer 42 and also sufficiently improves adherence between the bonding layer 43 and the insulating layer 42.

In this case also, the sealing characteristic and the insulating characteristic of the sealing member 40 are secured. Accordingly, it is possible to achieve similar effects. In this case, in particular, falling-off of each of the bonding layers 41 and 43 from the insulating layer 42 is suppressed. Accordingly, it is possible to markedly improve the sealing characteristic.

It should be understood that the sealing member 40 may include only one of the bonding accelerator layers 44 and 45. A reason for this is that, providing even one of the bonding accelerator layers 44 and 45 in the sealing member 40 improves the sealing characteristic of the sealing member 40, as compared with a case where the sealing member 40 includes neither the bonding accelerator layer 44 nor 45.

### [Modification 8]

The separator 34 which is a porous film is used. However, although not specifically illustrated here, a separator of a stack type including a polymer compound layer may be used instead of the separator 34 which is the porous film.

Specifically, the separator of the stack type includes: a base layer which is the above-described porous film; and a polymer compound layer provided on one side or each of both sides of the base layer. A reason for this is that adherence of the separator to each of the positive electrode 32 and the negative electrode 33 improves to suppress occurrence of positional deviation of the battery device 30. This helps to reduce swelling of the secondary batteries 100 and 200 even if, for example, a decomposition reaction of the electrolytic solution occurs. The polymer compound layer includes a polymer compound such as polyvinylidene difluoride. A reason for this is that such a polymer compound has superior physical strength and is electrochemically stable.

It should be understood that the base layer, the polymer compound layer, or both may each include one or more kinds of particles including, without limitation, inorganic particles and resin particles. A reason for this is that heat is released by the particles when the secondary batteries 100 and 200 generate heat, which improves heat resistance and safety of the secondary batteries 100 and 200. The particles include one or more of aluminum oxide (alumina), aluminum nitride, boehmite, silicon oxide (silica), titanium oxide (titania), magnesium oxide (magnesia), and zirconium oxide (zirconia).

In a case of fabricating the separator of the stack type, a precursor solution that includes materials including, without limitation, the polymer compound and an organic solvent is prepared, following which the precursor solution is applied on one side or each of both sides of the base layer.

Similar effects are obtainable also in the case where the separator of the stack type is used, because lithium is movable between the positive electrode 32 and the negative electrode 33.

### [Modification 9]

The electrolytic solution which is a liquid electrolyte is included. However, although not specifically illustrated here, an electrolyte layer which is a gel electrolyte may be included instead of the electrolytic solution.

In the battery device 30 including the electrolyte layer, the positive electrode 32 and the negative electrode 33 are stacked with the separator 34 and the electrolyte layer interposed therebetween. In this case, the electrolyte layer is interposed between the positive electrode 32 and the separator 34, and the electrolyte layer is also interposed between the negative electrode 33 and the separator 34.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution that includes materials including, without limitation, the electrolytic solution, the polymer compound, and an organic solvent is prepared, following which the precursor solution is applied on both sides of each of the positive electrode 32 and the negative electrode 33.

In the case of using the electrolyte layer also, lithium is movable between the positive electrode 32 and the negative electrode 33 via the electrolyte layer. Accordingly, it is possible to achieve similar effects.

It should be understood that, in one example, the electrolyte layer may be interposed between the positive electrode 32 and the separator 34, and the electrolyte layer may not be interposed between the negative electrode 33 and the separator 34. In another example, the electrolyte layer may not be interposed between the positive electrode 32 and the separator 34, and the electrolyte layer may be interposed between the negative electrode 33 and the separator 34.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. It should be understood that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are merely examples, and are appropriately modifiable.

FIG. 34 illustrates a block configuration of a battery pack including a single battery. The battery pack described here is a simple battery pack (a so-called soft pack) including one secondary battery, and is to be mounted on, for example, electronic equipment typified by a smartphone.

As illustrated in FIG. 34, the battery pack includes an electric power source 61 and a circuit board 62. The circuit board 62 is coupled to the electric power source 61, and includes a positive electrode terminal 63, a negative electrode terminal 64, and a temperature detection terminal (a so-called T terminal) 65.

The electric power source 61 includes one secondary battery. The secondary battery has a positive electrode lead coupled to the positive electrode terminal 63 and a negative electrode lead coupled to the negative electrode terminal 64. The electric power source 61 is couplable to outside via the positive electrode terminal 63 and the negative electrode terminal 64, and is thus chargeable and dischargeable via the positive electrode terminal 63 and the negative electrode terminal 64. The circuit board 62 includes a controller 66, a switch 67, a PTC device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a battery voltage of the electric power source 61 (the secondary battery) reaches an overcharge detection voltage or an overdischarge detection voltage, the controller 66 turns off the switch 67. This prevents a charging current from flowing into a current path of the electric power source 61. In addition, if a large current flows upon charging or discharging, the controller 66 turns off the switch 67 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 67 is a switch unit that includes, for example, a charge control switch, a discharge control switch, a charging diode, and/or a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET) including a metal-oxide semiconductor. The charging and discharging currents are detected on the basis of an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, in a case where the controller 66 performs charge/discharge control upon abnormal heat generation or in a case where the controller 66 performs a correction process upon calculating a remaining capacity.

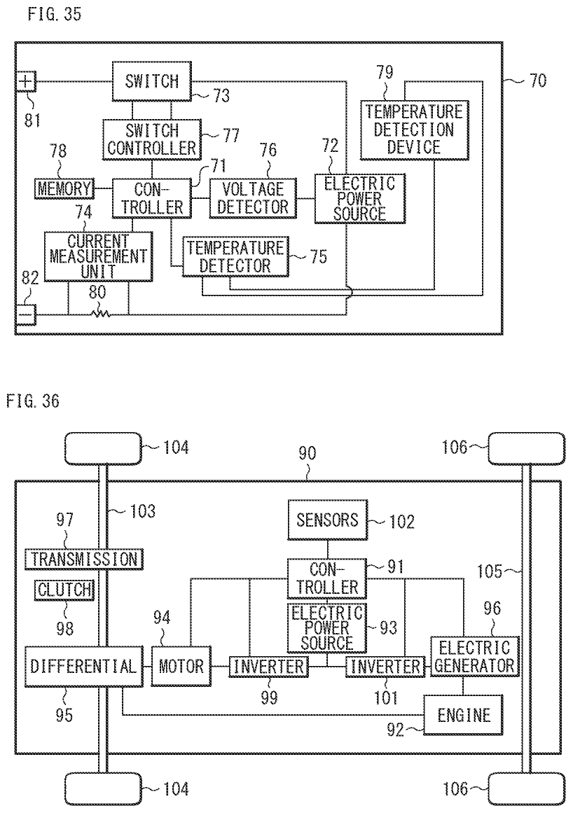

FIG. 35 illustrates a block configuration of a battery pack including an assembled battery. In the following description, reference will be made as necessary to the components of the battery pack including the single battery (FIG. 34).

As illustrated in FIG. 35, the battery pack includes a positive electrode terminal 81 and a negative electrode terminal 82. Specifically, the battery pack includes, inside a housing 70, the following components: a controller 71, an electric power source 72, a switch 73 that is a switch unit, a current measurement unit 74, a temperature detector 75, a voltage detector 76, a switch controller 77, a memory 78, a temperature detection device 79, and a current detection resistor 80.

The electric power source 72 includes an assembled battery in which two or more secondary batteries are coupled to each other, and a type of the coupling of the two or more secondary batteries is not particularly limited. Accordingly, the coupling scheme may be in series, in parallel, or of a mixed type of both. For example, the electric power source 72 includes six secondary batteries coupled to each other in two parallel and three series.

Configurations of the controller 71, the switch 73, the temperature detector 75, and the temperature detection device 79 are similar to those of the controller 66, the switch 67, and the temperature detector 69 (the temperature detection device). The current measurement unit 74 measures a current using the current detection resistor 80, and outputs a result of the measurement of the current to the controller 71. The voltage detector 76 measures a battery voltage of the electric power source 72 (the secondary battery) and provides the controller 71 with a result of the measurement of the voltage that has been subjected to analog-to-digital conversion.

The switch controller 77 controls an operation of the switch 73 in response to signals supplied by the current measurement unit 74 and the voltage detector 76. If a battery voltage reaches an overcharge detection voltage or an overdischarge detection voltage, the switch controller 77 turns off the switch 73 (the charge control switch). This prevents a charging current from flowing into a current path of the electric power source 72. This enables the electric power source 72 to perform only discharging through the discharging diode, or only charging through the charging diode. In addition, if a large current flows upon charging or discharging, the switch controller 77 blocks the charging current or the discharging current.

The switch controller 77 may be omitted and the controller 71 may thus also serve as the switch controller 77. The overcharge detection voltage and the overdischarge detection voltage are not particularly limited, and are similar to those described above in relation to the battery pack including the single battery.

The memory 78 includes, for example, an electrically erasable programmable read-only memory (EEPROM) which is a non-volatile memory, and the memory 78 stores, for example, a numeric value calculated by the controller 71 and data (e.g., an initial internal resistance, a full charge capacity, and a remaining capacity) of the secondary battery measured in the manufacturing process.

The positive electrode terminal 81 and the negative electrode terminal 82 are terminals coupled to, for example, external equipment that operates using the battery pack, such as a laptop personal computer, or external equipment that is used to charge the battery pack, such as a charger. The electric power source 72 (the secondary battery) is chargeable and dischargeable through the positive electrode terminal 81 and the negative electrode terminal 82.

FIG. 36 illustrates a block configuration of a hybrid automobile which is an example of the electric vehicle. As illustrated in FIG. 36, the electric vehicle includes, inside a housing 90, the following components: a controller 91, an engine 92, an electric power source 93, a motor 94, a differential 95, an electric generator 96, a transmission 97, a clutch 98, inverters 99 and 101, and sensors 102. The electric vehicle also includes a front wheel drive shaft 103, a pair of front wheels 104, a rear wheel drive shaft 105, and a pair of rear wheels 106. The front wheel drive shaft 103 and the pair of front wheels 104 are coupled to the differential 95 and the transmission 97.

The electric vehicle is configured to travel by using one of the engine 92 and the motor 94 as a driving source. The engine 92 is a major power source, such as a gasoline engine. In a case where the engine 92 is used as a power source, a driving force (a rotational force) of the engine 92 is transmitted to the front wheels 104 and the rear wheels 106 via the differential 95, the transmission 97, and the clutch 98, which are driving parts. It should be understood that the rotational force of the engine 92 is transmitted to the electric generator 96, and the electric generator 96 thus generates alternating-current power by utilizing the rotational force. In addition, the alternating-current power is converted into direct-current power via the inverter 101, and the direct-current power is thus accumulated in the electric power source 93. In contrast, in a case where the motor 94 which is a converter is used as a power source, electric power (direct-current power) supplied from the electric power source 93 is converted into alternating-current power via the inverter 99. Thus, the motor 94 is driven by utilizing the alternating-current power. A driving force (a rotational force) converted from the electric power by the motor 94 is transmitted to the front wheels 104 and the rear wheels 105 via the differential 95, the transmission 97, and the clutch 98, which are the driving parts.

When the electric vehicle is decelerated by means of a brake mechanism, a resistance force at the time of the deceleration is transmitted as a rotational force to the motor 94. Thus, the motor 94 may generate alternating-current power by utilizing the rotational force. The alternating-current power is converted into direct-current power via the inverter 99, and direct-current regenerative power is accumulated in the electric power source 93.

The controller 91 includes, for example, a CPU, and controls an overall operation of the electric vehicle. The electric power source 93 includes one or more secondary batteries and is coupled to an external electric power source. In this case, the electric power source 93 may be supplied with electric power from the external electric power source and thereby accumulate the electric power. The sensors 102 are used to control the number of revolutions of the engine 92 and to control an angle of a throttle valve (a throttle angle). The sensors 102 include one or more of sensors including, without limitation, a speed sensor, an acceleration sensor, and an engine speed sensor.

The case where the electric vehicle is a hybrid automobile has been described as an example; however, the electric vehicle may be a vehicle that operates using only the electric power source 93 and the motor 94 and not using the engine 92, such as an electric automobile.

Although not specifically illustrated here, other application examples are also conceivable as application examples of the secondary battery.

Specifically, the secondary battery is applicable to an electric power storage system. The electric power storage system includes, inside a building such as a residential house or a commercial building, the following components: a controller, an electric power source including one or more secondary batteries, a smart meter, and a power hub.

The electric power source is coupled to electric equipment such as a refrigerator installed inside the building, and is couplable to an electric vehicle such as a hybrid automobile stopped outside the building. Further, the electric power source is coupled, via the power hub, to a home power generator such as a solar power generator installed at the building, and is also coupled, via the smart meter and the power hub, to a centralized power system of an external power station such as a thermal power station.

Alternatively, the secondary battery is applicable to an electric power tool such as an electric drill or an electric saw. The electric power tool includes, inside a housing to which a movable part such as a drilling part or a saw blade part is attached, the following components: a controller, and an electric power source including one or more secondary batteries.

### EXAMPLES

A description is given of Examples of the technology below.

### Experiment Examples 1 to 10

The secondary battery 100 with no electrode terminal illustrated in FIGS. 1 to 3 and the secondary battery 200 with the electrode terminal illustrated in FIGS. 4 to 6 were fabricated, following which a battery characteristic of each of the secondary batteries 100 and 200 was evaluated.

By the following procedure, the secondary battery 100 using the battery device 30 of Configuration example 2 was fabricated and the secondary battery 200 using the battery device 30 of each of Configuration examples 4 and 6 was also fabricated.

(Fabrication of Secondary Battery with No Electrode Terminal Using Battery Device of Configuration Example 2)

First, the positive electrode 32 was fabricated. In this case, first, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on one side of the positive electrode current collector 32A (an aluminum foil having a thickness of 12 μm) including no protruding part 32C by means of a coating apparatus, following which the applied positive electrode mixture slurry was dried to thereby form the positive electrode active material layer 32B. Lastly, the positive electrode active material layer 32B was compression-molded by means of a roll pressing machine. Thus, the positive electrode active material layer 32B was formed on one side of the positive electrode current collector 32A. As a result, the positive electrode 32 was fabricated.

Thereafter, the negative electrode 33 was fabricated. In this case, first, 93 parts by mass of the negative electrode active material (graphite) and 7 parts by mass of the positive electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on one side of the negative electrode current collector 33A (a copper foil having a thickness of 15 μm) with no protruding part 33C by means of a coating apparatus, following which the applied negative electrode mixture slurry was dried to thereby form the negative electrode active material layer 33B. Lastly, the negative electrode active material layer 33B was compression-molded by means of a roll pressing machine. Thus, the negative electrode active material layer 33B was formed on each of both sides of the negative electrode current collector 33A. As a result, the negative electrode 33 was fabricated.

Thereafter, the electrolytic solution was prepared. In this case, the electrolyte salt (lithium hexafluorophosphate) was put into a solvent (ethylene carbonate and ethyl methyl carbonate), following which the solvent was stirred. A mixture ratio (a weight ratio) between ethylene carbonate and ethyl methyl carbonate in the solvent was set to 50:50. The content of the electrolyte salt was set to 1 mol/kg with respect to the solvent. Thus, the electrolyte salt was dispersed or dissolved in the solvent. As a result, the electrolytic solution was prepared.

Lastly, the secondary battery 100 was assembled with use of the positive electrode 32, the negative electrode 33, and the electrolytic solution. First, the positive electrode 32 and the negative electrode 33 were stacked on each other with the separator 34 (a porous polyethylene film having a thickness of 15 μm) impregnated with the electrolytic solution interposed therebetween. In this case, the respective orientations of the positive electrode 32 and the negative electrode 33 were so adjusted that the positive electrode active material layer 32B and the negative electrode active material layer 33B are opposed to each other with the separator 34 interposed therebetween. Thus, each of the positive electrode 32 and the negative electrode 33 was impregnated with a portion of the electrolytic solution. This completed the fabrication of the battery device 30 of Configuration example 2 in which the uppermost-layer electrode 35 was the positive electrode 32 and the lowermost-layer electrode 36 was the negative electrode 33 as illustrated in FIGS. 12 and 13.

Thereafter, the battery device 30 was placed between the upper-layer electrically conductive outer package member 10 and the lower-layer electrically conductive outer package member 20 with the sealing member 40 (40M) illustrated in FIGS. 7 and 8 being interposed between the upper-layer electrically conductive outer package member 10 and the lower-layer electrically conductive outer package member 20. In this case, the battery device 30 was placed inside the opening 40K to thereby allow the battery device 30 to be sandwiched by the upper-layer electrically conductive outer package member 10 and the lower-layer electrically conductive outer package member 20 with the sealing member 40 interposed between the upper-layer electrically conductive outer package member 10 and the lower-layer electrically conductive outer package member 20. Used here was the sealing member 40 having the multilayer structure including the bonding layers 41 and 43 and the insulating layer 42 illustrated in FIG. 8. In this case, as described in Table 1, one sealing member 40M or two sealing members 40M were used. In a case of using two sealing members 40M, the two sealing members 40M were stacked on each other. A detailed configuration, including a material, a thickness in micrometer, a layer structure, and a kind, of each of the upper-layer electrically conductive outer package member 10, the lower-layer electrically conductive outer package member 20, and the sealing member 40 was as listed in Table 1.

Details of the “kind” of the sealing member 40 are as described below. “40M×1” represents the use of one sealing member 40M. “40M×2” represents the use of two sealing members 40M.

As each of the bonding layers 41 and 43, a film of maleic-acid-modified polypropylene (PP), which is an acid-modified polyolefin, was used. As the insulating layer 42, a film of a copolymer of ethylene and tetrafluoroethylene (ETFE), which is a fluorine-based resin, was used.

Lastly, the bonding layer 41 was bonded to the upper-layer electrically conductive outer package member 10 and the bonding layer 43 was bonded to the lower-layer electrically conductive outer package member 20 by a thermal fusion bonding method. Thus, the gap between the upper-layer electrically conductive outer package member 10 and the lower-layer electrically conductive outer package member 20, i.e., the region surrounding the battery device 30, was sealed in a state with the battery device 30 being sandwiched between the upper-layer electrically conductive outer package member 10 and the lower-layer electrically conductive outer package member 20. As a result, the secondary battery 100 with no electrode terminal illustrated in FIGS. 1 to 3 was completed.

(Fabrication of Secondary Battery with Electrode Terminal Using Battery Device of Configuration Example 4)

The secondary battery 200 with the electrode terminal using the battery device 30 of Configuration example 4 was fabricated by performing a procedure similar to the procedure of fabricating the secondary battery 100 with no electrode terminal using the battery device 30 of Configuration example 2, except for the following.

In a case of fabricating the positive electrode 32, the positive electrode current collector 32A (an aluminum foil having a thickness of 12 μm) including the protruding part 32C, i.e., the electrode terminal 50 serving as the positive electrode terminal 32T, was used, and the positive electrode active material layer 32B was formed on each of both sides of the positive electrode current collector 32A other than the protruding part 32C.

In a case of fabricating the battery device 30, one positive electrode 32 and two negative electrodes 33 were stacked on each other with two separators 34 impregnated with the electrolytic solution interposed therebetween. In addition, the sealing member 40, i.e., any of the sealing members 40M and 40N, illustrated in FIGS. 7 to 9 was used. In this case, the respective orientations of the positive electrode 32 and the negative electrode 33 were so adjusted that the positive electrode active material layer 32B and the negative electrode active material layer 33B are opposed to each other with the separator 34 interposed therebetween. This completed the fabrication of the battery device 30 of Configuration example 4 in which the uppermost-layer electrode 35 was the negative electrode 33 and the lowermost-layer electrode 36 was the negative electrode 33 as illustrated in FIGS. 16 and 17.

A detailed configuration of each of the upper-layer electrically conductive outer package member 10, the lower-layer electrically conductive outer package member 20, and the sealing member 40 was as listed in Table 1.

Details of the “kind” of the sealing member 40 are as follow. As described above, “40M×2” represents the use of two sealing members 40M. “40M+40N” represents the combination use of one sealing member 40M and one sealing member 40N.

(Fabrication of Secondary Battery with Electrode Terminal Using Battery Device of Configuration Example 6)

The secondary battery 200 with the electrode terminal using the battery device 30 of Configuration example 6 was fabricated by performing a procedure similar to the procedure of fabricating the secondary battery 100 with no electrode terminal using the battery device 30 of Configuration example 2, except for the following.

In a case of fabricating the negative electrode 33, the negative electrode current collector 33A (a copper foil having a thickness of 15 μm) including the protruding part 33C, i.e., the electrode terminal 50 serving as the negative electrode terminal 33T, was used, and the negative electrode active material layer 33B was formed on each of both sides of the negative electrode current collector 33A other than the protruding part 33C.

In a case of fabricating the battery device 30, two positive electrodes 32 and one negative electrode 33 were stacked on each other with two separators 34 impregnated with the electrolytic solution interposed therebetween. In addition, the sealing member 40, i.e., any of the sealing members 40M and 40N, illustrated in FIGS. 7 to 9 was used. In this case, the respective orientations of the positive electrode 32 and the negative electrode 33 were so adjusted that the positive electrode active material layer 32B and the negative electrode active material layer 33B are opposed to each other with the separator 34 interposed therebetween. This completed the fabrication of the battery device 30 of Configuration example 6 in which the uppermost-layer electrode 35 was the positive electrode 32 and the lowermost-layer electrode 36 was the positive electrode 32 as illustrated in FIGS. 20 and 21.

A detailed configuration of each of the upper-layer electrically conductive outer package member 10, the lower-layer electrically conductive outer package member 20, and the sealing member 40 was as listed in Table 1.

For comparison, the secondary battery 100 with no electrode terminal and the secondary battery 200 with the electrode terminal described below were also fabricated.

Firstly, a procedure similar to the procedure of fabricating the secondary battery 100 with no electrode using the battery device 30 of Configuration example 2 was performed, except that a laminated film was used as an outer package member instead of the upper-layer electrically conductive outer package member 10 and the lower-layer electrically conductive outer package member 20 and that an additional electrode terminal was coupled to the battery device 30.

In a case of assembling the secondary battery 100 with use of the laminated film, first, two laminated films were prepared. Each of the laminated films had a configuration described in Table 1, and was a metal laminated film including an inner layer (a polyethylene (PE) film), a metal layer (an aluminum foil), and an outer layer (a PE film) stacked in this order. Thereafter, the battery device 30 was placed between the two laminated films. Lastly, respective outer edges of the laminated films (the inner layers) were heated to be thereby bonded to each other by a thermal fusion bonding method. In this case, one end of a lead line including aluminum was coupled to the positive electrode current collector 32A by a welding method, and another end of the lead line was led to outside of the laminated films. In addition, one end of a lead line including copper was coupled to the negative electrode current collector 33A by a welding method, and another end of the lead line was led to the outside the laminated films.

Secondly, a procedure similar to the procedure of fabricating the secondary battery 200 with the electrode using the battery device 30 of each of Configuration examples 4 and 6 was performed, except that the sealing member 40 (a PE film) having a single-layer structure was used instead of the sealing member 40 having the multilayer structure including the bonding layers 41 and 43 and the insulating layer 42. The single-layer sealing member 40 had a configuration described in Table 1.

TABLE 1

| | | | | | Upper-layer | | | | | Lower-layer | | | |
|---|---|---|---|---|---|---|---|---|---|---|---|---|---|
| | | | | | electrically | | | | | electrically | | | |
| | | | | | conductive | | | | | conductive | | | |
| | | | | | outer package | | | | | outer package | | Weight | Capacity |
| Exper- | | Battery device | | | member | | Sealing member | | | member | | vari- | reten- |
| iment | | Config- | Uppermost- | Lowermost- | | Thick- | | Thick- | | | Thick- | ation | tion |
| exam- | Electrode | uration | layer | layer | | ness | Layer | ness | | | ness | rate | rate |
| ple | terminal | example | electrode | electrode | Material | (μm) | structure | (μm) | Kind | Material | (μm) | (%) | (%) |
| 1 | No | 2 | Positive | Negative | Alumi- | 20 | Multi- | 100 | 40M × 1 | Copper | 20 | −3.3 | 90.4 |
| | electrode | | electrode | electrode | num | | layer | | | | | | |
| | terminal | | | | | | | | | | | | |
| 2 | No | 2 | Positive | Negative | Alumi- | 20 | Multi- | 100 | 40M × 2 | Copper | 20 | −1.9 | 91.2 |
| | electrode | | electrode | electrode | num | | layer | | | | | | |
| | terminal | | | | | | | | | | | | |
| 3 | With | 4 | Negative | Negative | Copper | 20 | Multi- | 100 | 40M + | Copper | 20 | −3.5 | 90.0 |
| | electrode | | electrode | electrode | | | layer | | 40N | | | | |
| | terminal | | | | | | | | | | | | |
| 4 | With | 4 | Negative | Negative | Copper | 20 | Multi- | 100 | 40M × 2 | Copper | 20 | −1.8 | 91.1 |
| | electrode | | electrode | electrode | | | layer | | | | | | |
| | terminal | | | | | | | | | | | | |
| 5 | With | 6 | Positive | Positive | Alumi- | 20 | Multi- | 100 | 40M + | Alumi- | 20 | −3.1 | 90.6 |
| | electrode | | electrode | electrode | num | | layer | | 40N | num | | | |
| | terminal | | | | | | | | | | | | |
| 6 | With | 6 | Positive | Positive | Alumi- | 20 | Multi- | 100 | 40M × 2 | Alumi- | 20 | −1.7 | 91.2 |
| | electrode | | electrode | electrode | num | | layer | | | num | | | |
| | terminal | | | | | | | | | | | | |
| 7 | No | 2 | Positive | Negative | Lami- | 100 | — | — | — | Lami- | 100 | −16.5 | 73.8 |
| | electrode | | electrode | electrode | nated | | | | | nated | | | |
| | terminal | | | | film | | | | | film | | | |
| 8 | No | 2 | Positive | Negative | Alumi- | 20 | Single | 100 | 40M × 1 | Copper | 20 | −24.8 | 51.2 |
| | electrode | | electrode | electrode | num | | layer | | | | | | |
| | terminal | | | | | | | | | | | | |
| 9 | With | 4 | Negative | Negative | Copper | 20 | Single | 100 | 40M + | Copper | 20 | −26.3 | 49.7 |
| | electrode | | electrode | electrode | | | layer | | 40N | | | | |
| | terminal | | | | | | | | | | | | |
| 10 | With | 6 | Positive | Positive | Alumi- | 20 | Single | 100 | 40M + | Alumi- | 20 | −29.3 | 50.1 |
| | electrode | | electrode | electrode | num | | layer | | 40N | num | | | |
| | terminal | | | | | | | | | | | | |

* Sealing member (layer structure = multilayer): Bonding layer (maleic-acid-modified PP film, 35 μm)/Insulating layer (ETFE film, 30 μm)/Bonding layer (maleic-acid-modified PP film, 35 μm)
* Laminated film: Outer layer (PE film, 50 μm)/Metal layer (aluminum foil, 20 μm)/Inner layer (PE film, 30 μm)
* Sealing member (layer structure = single layer): PE film (100 μm)

Evaluation of a battery characteristic (a hermetically sealing characteristic and a cyclability characteristic) of the secondary batteries 100 and 200 revealed the results described in Table 1.

In a case of examining the hermetically sealing characteristic, first, the secondary battery 100 or 200 was fabricated with use of 100 μl (=100 mm³) of the electrolytic solution by the above-described fabrication procedure, following which a weight (a pre-storage weight) of the secondary battery 100 or 200 was measured. Thereafter, the secondary battery 100 or 200 was stored in a thermostatic chamber at a temperature of 60° C. for a storing time of 90 days, following which the weight (a post-storage weight) of the secondary battery 100 or 200 was measured. Lastly, the following was calculated: weight variation rate (%)=[(post-storage weight−pre-storage weight)/pre-storage weight]×100.

In a case of examining the cyclability characteristic, first, the secondary battery was charged and discharged for one cycle in an ambient temperature environment at a temperature of 23° C. in order to stabilize a state of the secondary battery. Thereafter, the secondary battery was charged and discharged for another cycle in the same environment, to thereby measure a second-cycle discharge capacity. Thereafter, the secondary battery was repeatedly charged and discharged in the same environment until the total number of cycles reached 500, to thereby measure a 500th-cycle discharge capacity. Lastly, the following was calculated: capacity retention rate (%)=(500th-cycle discharge capacity/second-cycle discharge capacity)×100.

Upon charging, the secondary battery was charged with a constant current of 0.5 C until a voltage reached 4.20 V, and was thereafter charged with a constant voltage of 4.20 V until a current reached 0.02 C. Upon discharging, the secondary battery was charged with a constant current of 0.2 C until a voltage reached 3.00 V. It should be understood that 0.5 C is a value of a current that causes a battery capacity (a theoretical capacity) to be completely discharged in 2 hours, 0.02 C is a value of a current that causes the battery capacity to be completely discharged in 50 hours, and 0.2 C is a value of a current that causes the battery capacity to be completely discharged in 5 hours.

As can be seen from Table 1, the battery characteristic varied greatly depending on the configuration of the sealing member 40.

Specifically, in a case where the laminated film (the metal laminated film), which is to be used in a secondary battery of a so-called laminated-film type, was used (Experiment example 7), the weight variation rate reached double digits, and the capacity retention rate decreased down to the 70% range. A reason for this seems to be that insufficiency of the sealed state of the secondary battery caused leakage of the electrolytic solution from inside of the secondary battery to outside through a gap in the metal laminated film during the storage period, resulting in a decrease in the amount of the electrolytic solution left inside the secondary battery.

Further, in a case where the single-layer sealing member 40 was used (Experiment examples 8 to 10), as compared with the above-described case where the laminated film was used (Experiment example 7), the weight variation rate further increased and the capacity retention rate further decreased. A reason for this seems to be that the lack of the sealed state of the secondary battery caused a greater amount of leakage of the electrolytic solution during the storage period, resulting in a decrease in the amount of the electrolytic solution left inside the secondary battery.

In contrast, in a case where the sealing member 40 having the multilayer structure (bonding layer/insulating layer/bonding layer) was used (Experiment examples 1, 3, and 5), as compared with the above-described case where the laminated film was used (Experiment example 7), the weight variation rate greatly decreased and the capacity retention rate greatly increased. Specifically, the use of the multilayer sealing member 40 suppressed the weight variation rate to the first half of the single digit, and achieved a high capacity retention rate of 90% or higher. A reason for this seems to be that the sufficiency of the sealed state of the secondary battery greatly reduced the amount of leakage of the electrolytic solution during the storage period, resulting in a great increase in the amount of the electrolytic solution left inside the secondary battery.

In particular, regarding the secondary battery 100 with no electrode terminal, in a case where two sealing members 40M were used (Experiment example 2), the weight variation rate further decreased and the capacity retention rate further increased, as compared with a case where a single sealing member 40M was used (Experiment example 1). Regarding the secondary battery 200 with the electrode, in a case where two sealing members 40M were used (Experiment examples 4 and 6), the weight variation rate further decreased and the capacity retention rate further increased, as compared with a case where the sealing members 40M and 40N were used in combination (Experiment examples 3 and 5).

The results described in Table 1 indicate that, regarding the secondary batteries (the secondary battery 100 with no electrode and the secondary battery 200 with the electrode), in a case where: the battery device 30 including the electrodes 31 stacked on each other with the separator 34 therebetween was disposed between the upper-layer electrically conductive outer package member 10 and the lower-layer electrically conductive outer package member 20; and the sealing member 40 including the bonding layer 41 (the polyolefin-based resin), the insulating layer 42 (the insulating resin), and the bonding layer 43 (the polyolefin-based resin) was disposed in a portion or all of the region surrounding the battery device 30 between the upper-layer electrically conductive outer package member 10 and the lower-layer electrically conductive outer package member 20, a superior hermetically sealing characteristic was achieved, and therefore, a superior cyclability characteristic was also achieved. The secondary battery thus achieved a superior battery characteristic.

Although the technology has been described above with reference to some embodiments and Examples, the configuration of the technology is not limited to those described with reference to the embodiments and Examples above, and is therefore modifiable in a variety of ways.

Specifically, although the description above relates to a case where the battery device has a stacked-type device structure, the device structure of the battery device is not particularly limited. Specifically, the device structure of the battery device may be a wound structure in which the components including the electrodes (the positive electrode and the negative electrode) are wound, or may be of a zigzag folded type in which the components including the electrodes are folded in a zigzag manner.

Moreover, although the description above relates to the lithium-ion secondary battery that obtains the battery capacity by utilizing insertion and extraction of lithium, the kind of the second battery is not particularly limited. Specifically, the kind of the secondary battery may be a lithium-metal secondary battery that obtains a battery capacity by utilizing precipitation and dissolution of lithium. Alternatively, the kind of the secondary battery may be a secondary battery that obtains both the battery capacity derived from the insertion and the extraction of lithium and the battery capacity derived from the precipitation and the dissolution of lithium. In this case, a material into which lithium is insertable and from which lithium is extractable is used as the negative electrode active material, and the chargeable capacity of the negative electrode active material is set to be smaller than the discharge capacity of the positive electrode active material.

Further, although the description above relates to a case where the electrode reactant is lithium, the electrode reactant is not particularly limited. Specifically, the electrode reactant may be a light metal other than lithium. Such light metal may be another alkali metal such as sodium or potassium, may be an alkaline earth metal such as beryllium, magnesium, or calcium, or may be another light metal such as aluminum.

The effects described herein are mere examples, and effects of the technology are therefore not limited to those described herein. Accordingly, the technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a first electrically conductive member;
a second electrically conductive member opposed to the first electrically conductive member;
a battery device provided between the first electrically conductive member and the second electrically conductive member, wherein the battery device includes two or more electrodes stacked on each other in an opposing direction with a separator interposed therebetween, and wherein the opposing direction is a direction in which the first electrically conductive member and the second electrically conductive member are opposed to each other, and wherein the electrodes include a first electrode and a second electrode, and wherein the first electrode is adjacent to the first electrically conductive member, and the second electrode is adjacent to the second electrically conductive member; and
a sealing member provided in at least a portion of a region surrounding the battery device between the first electrically conductive member and the second electrically conductive member, wherein the sealing member includes a first bonding layer, an insulating layer, and a second bonding layer that are stacked in order in the opposing direction, and wherein the first bonding layer and the second bonding layer each include a polyolefin-based resin, and the insulating layer includes an insulating resin.

2. The secondary battery according to claim 1, wherein the polyolefin-based resin includes an acid-modified polyolefin.

3. The secondary battery according to claim 1, wherein the insulating resin includes at least one of a polyester-based resin, a polyamide-based resin, an epoxy-based resin, an acrylic-based resin, a fluorine-based resin, a polyurethane-based resin, a silicon-based resin, a phenol-based resin, or a copolymer of two or more thereof.

4. The secondary battery according to claim 2, wherein the insulating resin includes at least one of a polyester-based resin, a polyamide-based resin, an epoxy-based resin, an acrylic-based resin, a fluorine-based resin, a polyurethane-based resin, a silicon-based resin, a phenol-based resin, or a copolymer of two or more thereof.

5. The secondary battery according to claim 1, wherein the first electrode, the second electrode, or both include an active material layer, and
the first electrically conductive member, the second electrically conductive member, or both are adjacent to the active material layer.

6. The secondary battery according to claim 2, wherein the first electrode, the second electrode, or both include an active material layer, and
the first electrically conductive member, the second electrically conductive member, or both are adjacent to the active material layer.

7. The secondary battery according to claim 3, wherein the first electrode, the second electrode, or both include an active material layer, and
the first electrically conductive member, the second electrically conductive member, or both are adjacent to the active material layer.

8. The secondary battery according to claim 1, wherein
the first electrode, the second electrode, or both include a current collector and an active material layer that are stacked in the opposing direction, and
the first electrically conductive member, the second electrically conductive member, or both are adjacent to the current collector.

9. The secondary battery according to claim 2, wherein
the first electrode, the second electrode, or both include a current collector and an active material layer that are stacked in the opposing direction, and
the first electrically conductive member, the second electrically conductive member, or both are adjacent to the current collector.

10. The secondary battery according to claim 1, wherein
the electrodes include a positive electrode and a negative electrode that are stacked on each other in the opposing direction with the separator interposed therebetween,
the first electrode comprises one of the positive electrode and the negative electrode, and
the second electrode comprises another of the positive electrode and the negative electrode.

11. The secondary battery according to claim 1, wherein
the electrodes include a first negative electrode, a positive electrode, and a second negative electrode that are stacked in order in the opposing direction,
the first electrode comprises the first negative electrode, and
the second electrode comprises the second negative electrode.

12. The secondary battery according to claim 11, further comprising a positive electrode terminal coupled to the positive electrode and led to outside of a region between the first electrically conductive member and the second electrically conductive member.

13. The secondary battery according to claim 7, wherein the first negative electrode and the second negative electrode are joined to each other.

14. The secondary battery according to claim 1, wherein
the electrodes include a first positive electrode, a negative electrode, and a second positive electrode that are stacked in order in the opposing direction,
the first electrode comprises the first positive electrode, and
the second electrode comprises the second positive electrode.

15. The secondary battery according to claim 14, further comprising a negative electrode terminal coupled to the negative electrode and led to outside of a region between the first electrically conductive member and the second electrically conductive member.

16. The secondary battery according to claim 14, wherein the first positive electrode and the second positive electrode are joined to each other.

17. The secondary battery according to claim 1, wherein the first electrically conductive member and the second electrically conductive member are joined to each other.

18. The secondary battery according to claim 1, wherein
the sealing member comprises two or more sealing members, and
the sealing members are stacked on each other in the opposing direction.

19. The secondary battery according to claim 1, wherein
the sealing member further includes a first adhesive layer, a second adhesive layer, or both, wherein the first adhesive layer is interposed between the first bonding layer and the insulating layer and is configured to improve adherence between the first bonding layer and the insulating layer, and wherein the second adhesive layer is interposed between the second bonding layer and the insulating layer and is configured to improve adherence between the second bonding layer and the insulating layer, and
the first adhesive layer and the second adhesive layer each include at least one of an isocyanate-based bonding accelerator, a polyethyleneimine-based bonding accelerator, a polyester-based bonding accelerator, a polyurethane-based bonding accelerator, or a polybutadiene-based bonding accelerator.

20. A battery pack comprising:
the secondary battery according to claim 1;
a controller that controls operation of the secondary battery; and
a switch that switches the operation of the secondary battery in accordance with an instruction from the controller.
